(19) United States
(12) Patent Application Publication
(10) Pub. No.: US 2023/0368513 A1
(43) Pub. Date: Nov. 16, 2023

(54) METHOD AND SYSTEM FOR TRAINING A NEURAL NETWORK

(71) Applicant: Academy of Robotics, Cardiff (GB)

(72) Inventors: Aparajit NARAYAN, Cardiff (GB); Pasihapaori CHIDZIVA, Cardiff (GB)

(21) Appl. No.: 18/246,479

(22) PCT Filed: Sep. 24, 2021
(86) PCT No.: PCT/GB2021/052488

§ 371 Date: Mar. 23, 2023

(30) Foreign Application Priority Data
Sep. 24, 2020 (GB) 2015128.8

(51) Int. Cl. G06V 10/82; G06V 10/778; G06V 20/56

(52) U.S. Cl. CPC G06V 10/82; G06V 10/7788; G06V 20/56

(57) ABSTRACT

A computer-implemented method and system for training a neural network are provided. The method includes generating a first plurality including a plurality of sets of weights for a neural network; evaluating each set of weights in the first plurality, wherein evaluating includes, for each set of weights: fitting the set of weights to a neural network; presenting training data to an input of the neural network; and calculating a fitness score for the set of weights based on a fitness function that is dependent on an output of the neural network, wherein evaluating each set of weights occurs at least partly concurrently, such that two or more sets of weights in the first plurality are evaluated at the same time; and generating a second plurality including a plurality of sets of weights for the neural network, wherein generating the second plurality includes applying a training algorithm to the sets of weights of the first plurality to generate the second plurality, the sets of weights of the second plurality being dependent on the sets of weights of the their respective fitness scores. The system comprises a primary module configured to implement the method apart from the evaluation, which is done at a secondary module which has parallel computing capabilities.

### TECHNICAL FIELD

This invention relates to a method and system for training a neural network, and in particular, a method of training a neural network for controlling a vehicle, such as for identifying a feature in the environment of a vehicle to and subsequently directing the vehicle.

### BACKGROUND OF THE INVENTION

A key component of an autonomous vehicle/assistance system is sensory perception. Sensory perception is the term that describes the capability to process input data from sensors and hardware, to obtain meaningful and useful results that can then be used to inform control of a certain system. Autonomous vehicles conventionally combine a variety of sensors to perceive their surroundings, including radar, Lidar, sonar, Global Positioning System (GPS), cameras and inertial measurement units. The data from these sensors is fed into advanced control systems to identify appropriate navigation paths, obstacles, hazards and relevant signage.

The advanced control systems may process several functions at once, and need to do so in a fast and efficient manner in order to deal with real-world problems whilst the autonomous vehicle is in transit. For example, the control systems must be able to extract which areas of an image plane, obtained from a camera, correspond to road (freespace), non-road (non-drivable areas), or obstacles such as cars, bicycles and pedestrians. This function must be performed continuously and accurately if the autonomous vehicle is to perform in an effective and safe manner.

One way in which this problem is being tackled is to use artificial intelligence (AI) to interpret the input data from the sensors and control the autonomous vehicle to react accordingly. The growth in AI and computer capabilities over the last two decades has enabled the use of Deep Neural networks (DNN) to perform such tasks. DNNs are a type of artificial neural network with multiple layers between input and output layers. DNNs are accurate at identifying objects in images, such as a car, a bicycle, or a pedestrian for example. DNNs are trained using large training datasets of similar images, to fine-tune the weights between specific neurons in the DNNs. Training is computationally demanding, and the multiple layers between input and output in DNNs requires specialised hardware to perform real-time inference on an autonomous vehicle. Some implementations use neural networks with pre-trained weights (on industry standard datasets), negating the need for a training process. However, in either of these instances, if the operational environment of an autonomous vehicle varies from the scope of the training dataset and pre-trained weights, the performance of the DNN will dramatically deteriorate unless it is re-trained or fine-tuned to the new constraints of the operational environment.

Another disadvantage of using DNNs that rely on large training datasets is that the DNNs rely on passive vision when interpreting an image. Passive vision refers to a vision processing system wherein the visual inputs that are received cannot be altered or changed in any way. This means that images are presented to the DNNs in the same way as they are captured, without any alterations in dimensions, view point, or colour combination. The majority of computer vision approaches including DNNs are passive vision systems. Using a passive vision system is less adaptable in the real-world, and can result in errors when the real world operational environment is different from that in which the system is trained.

It has been appreciated that it would be beneficial to achieve performance levels comparable with optimal DNNs whilst reducing the computational load (number of calculations/operations) and reliance on large datasets, to negate the problems set out above. A computer implemented method and system for training a low-resolution neural network that relies on active vision have been provided, to solve these problems.

### SUMMARY OF INVENTION

According to a first aspect of the invention, a computer-implemented method for training a neural network is provided. The method includes: generating a first plurality of sets of weights for a neural network; and evaluating each set of weights in the first plurality. The first plurality of sets of weights is referred henceforth as a first population. Evaluating includes, for each set of weights: fitting the set of weights to a neural network, meaning inputting the values of the weights from a set of weights into the connections of a neural network; presenting training data to an input of the neural network; and calculating a fitness score for the set of weights based on a fitness function that is dependent on an output of the neural network, wherein evaluating each set of weights occurs at least partly concurrently, such that two or more sets of weights in the first population are evaluated at the same time. The method further includes: generating a second plurality of sets of weights for the neural network, wherein generating the second plurality includes applying a training algorithm to the sets of weights of the first population to generate the second plurality of set of weights, the sets of weights of the second plurality being dependent on the sets of weights of the first population and their respective fitness scores. The second plurality of sets of weights is henceforth referred to as a second population.

This method of training a neural network is advantageously efficient, since possible sets of weights for the neural network are tested and their performance evaluated in an at least partly concurrent fashion. Partly concurrent means that at least two sets of weights within a population are evaluated simultaneously. This means that more sets of weights can be tested and evaluated faster when compared to conventional sequential training methods, where no concurrent evaluation is undertaken.

Preferably, the first population is an initial population, and the generating of the initial population includes randomly generating each set of weights in the initial population using a random number generator.

This has the advantage of removing bias from the training process, since the first population in the training process is completely random. Any suitable random number generator may be used to create weight values and sets of weights for the initial population.

Preferably, the training algorithm is an artificial evolution algorithm including one or more operations of elitism, mutation, recombination and truncation for generating the second population of sets of weights. The artificial evolution algorithm is preferably a genetic algorithm such as a continuous genetic algorithm. Any suitable genetic algorithm may be used. The evolution algorithm mimics biological evolution to manipulate the sets of weights of a previous population to generate the next population. The algorithm effectively optimises the sets of weights for a given task, defined by the fitness function, by manipulating the sets of weights in a population based on the fitness score of each of the sets of weights.

Preferably the one or more operations of the artificial evolution algorithm are applied to one or more of the sets of weights of the first population based on the fitness score of the sets of weights of the first population. Sets of weights with better fitness scores are considered to be better at performing the given task for which the weights are being trained. These sets of weights are more likely to appear in future generations, such as the second population, whilst sets of weights which have poor fitness scores are more likely to be removed from the next generation. Some sets of weights are selected to form a new set of weights in the next generation via mutation or crossover for example. This has the benefit of ensuring that the optimization of the sets of weights does not get stuck in local minima, and instead finds the global minimum, or the best selection of weight values, for the specific task being trained for.

Preferably generating the first population and generating the second population includes encoding each set of weights as an artificial chromosome. An artificial chromosome is a string or one-dimensional array of variables that is can be easily manipulated by the evolutionary operations such as mutation and crossover. The artificial chromosome may comprise discrete variables, such as binary code, or continuous variables. The variables in an artificial chromosomes correspond to the weights required for the neural network being trained. If there are 100 connections in a neural network with 100 weights, then each chromosome has 100 variables that correspond to the 100 weights, for example.

Preferably evaluating each of the sets of weights of the first population occurs concurrently, such that every set of weights in the first population is evaluated at the same time. This means each set of weights are tested and scored to provide a fitness score for each set of weights in a population, and that this process happens simultaneously. This is done using parallel computing and allows the training to be performed much more efficiently.

Preferably, the training data and the fitness function are dependent on a specific task that the neural network is being trained for, such as image classification, image segmentation, or object recognition.

One application of the training method is to train a neural network for use in an autonomous vehicle. In this case, the neural network can be used to process an image captured by a camera or LIDAR sensor for example. The training data here is an image but other sensor data from conventional autonomous vehicle sensors may also be used. For example, in some embodiments the training data may be data received by an autonomous vehicle sensor, such as a radar sensor, a LIDAR sensor, a camera, a charge-coupled device, an ultrasonic sensor, an infrared sensor or the like. The neural network may classify the image, segment the image, to identify road for example, or detect objects such as cars and pedestrians in the image. For each of these specific tasks, the training data has a known class, segment or object. When evaluating, if the neural network correctly identifies this known class, segment or object, the fitness score for the set of weights being evaluated is increased. If the neural network misidentifies the class, segment or object, the fitness score is decreased. The neural network is thus trained to be better at correctly identifying a particular feature of the environment of a vehicle, according to the training data and the specific task. An advantage of this is that the training method makes autonomous driving functions safer and more reliable.

Preferably, the evaluation of the sets of weights of the first population is performed using a parallel computing means. The parallel computing means may include a graphics processing unit (GPU) and/or a plurality of central processing units (CPUs). For example, the parallel computing means may be a GPU with multiple parallel computing blocks, or may be a cluster of connected CPUs. The parallel computing means is thus a device or system that allows the step of evaluating the performance of the sets of weights to be performed concurrently. In some embodiments, the parallel computing means may be implemented as a system on a chip (SoC), or a field-programmable gate array (FPGA).

Preferably when evaluating, the fitness score for a set of weights is greater when the output of the neural network, fitted with the set of weights, correctly indicates a property of the training data.

Preferably, when generating the second population, the method further comprises: ranking the set of weights of the first population according to their respective fitness scores; and generating the second population from the existing population by applying the training algorithm to the first population; wherein the training algorithm manipulates the sets of weights of the first population based on their ranking to generate the second population. The fitness scores may be ranked in an array or table of sets of weights and their corresponding fitness scores. This allows each set of weights to be easily manipulated by the training algorithm, according to their fitness score.

Preferably, the method further includes repeating the evaluating step with respect to the second population.

Preferably, the generating step and the evaluating step are repeated iteratively up to an nth population, such that the nth population is generated by applying the training algorithm to the sets of weights of the n−1th population to generate the nth population, the sets of weights of the nth population being dependent on the sets of weights of the n−1th population and their respective fitness scores; wherein n is a positive integer and n≥3. In general, more iterations of the method produce sets of weights or a final set of weights that, when fitted to a neural network, perform the specific task, for which the weights were trained, more accurately and reliably. Each new population, or the next generation, is formed by manipulating the previous population. As such, the second population is generated from the first population, the third population is generated from the second population, and so on. During generating each population the evolutionary operators discussed above may be used to alter and introduce variables to a population.

Preferably, the method includes: receiving a user selection of a set of weights in any population; and applying a biasing factor to the fitness score for the selected set of weights, such that the selected set of weights has a greater fitness score.

This allows a user, meaning an operator of the training method, to ensure that a set of weights are favoured in the training process. The user can select a set of weights at any time during the training process and may also initialise a set of weights manually by inputting the weights into the initial population. A benefit of this is the user can focus training on a specific set of weights, which may be useful at performing a specific task or be accurate at providing a particular role within a specific task, such as identifying a pavement in the specific task of image segmentation.

Preferably, the method further includes selecting a final set of weights from any population; saving the final weights to a memory; and subsequently inputting the final weights into a neural network for identifying a feature of an environment of a vehicle. The final weights may be automatically selected by selecting the set of weights with the best fitness score after all iterations of the training process are complete. Alternatively, the set of weights may be selected by a user. A plurality of sets of weights may be selected to input in a plurality of neural networks. The memory may be a flash drive, a local memory or a memory accessed via a server or the internet. The final set of weights may subsequently be retrieved from the memory and installed into a neural network, or they may be transferred directly from the computer device or system which performs the training method.

According to a second aspect of the invention, a system for training a neural network is provided, the system comprising a primary module and a secondary module that are communicatively coupled. The primary module is configured to generate a first population including a plurality of sets of weights for a neural network; and the secondary module is configured to evaluate each set of weights in the first population. Evaluating includes, for each set of weights: fitting the set of weights to a neural network; presenting training data to an input of the neural network; and calculating a fitness score for the set of weights based on a fitness function that is dependent on an output of the neural network. The secondary module is configured to evaluate each set of weights at least partly concurrently, such that two or more sets of weights in the first population are evaluated at the same time. The primary module is further configured to generate a second population including a plurality of sets of weights for the neural network, by applying a training algorithm to the sets of weights of the first population to generate the second population, the sets of weights of the second population being dependent on the sets of weights of the first population and their respective fitness scores.

Preferably, the primary module includes a central processing unit (CPU). The CPU may be included in any computer device, such as a computer, a mobile phone, a tablet, a smart device or the like. The CPU may be a standard processor, wherein the processor is configured to communicate with a memory device, the memory device having instructions stored thereon that cause the processor to implement and perform the role of the primary module.

Preferably, the secondary module includes a graphics processing unit (GPU) which comprises a plurality of parallel computing blocks, wherein each of the plurality of parallel computing blocks is configured to evaluate a set of weights from the first population, such that the plurality of parallel computing blocks are configured to concurrently evaluate multiple sets of weights from the first population. The GPU may be included in any computer device, such as a computer, a mobile phone, a tablet, a smart device or the like.

Preferably, the primary module is configured to send the first population to the GPU, and the GPU is configured to divide the plurality of sets of weights in the first population between the parallel computing blocks for evaluation. The GPU may have less parallel computing blocks than there are sets of weights. In this case, some or all of the parallel computing blocks are given multiple sets of weights, which they then sequentially evaluate. Preferably the number of parallel computing blocks is equal to the number of sets of weights in a population, such that each set of weights can be evaluated concurrently.

Alternatively the secondary module includes a cluster of multiple central processing units (CPUs), wherein each of the CPUs in the cluster is configured to evaluate a set of weights from the first population, such that the cluster of CPUs are configured to concurrently evaluate multiple sets of weights from the first population. The cluster of CPUs thus performs the same role as the GPU. Each CPU in the cluster is provided with at least one set of weights per population to evaluate. The cluster may have less CPUs than there are sets of weights. In this case, some or all of the CPUs are given multiple sets of weights, which they then sequentially evaluate. Preferably the number of CPUs is equal to the number of sets of weights in a population, such that each set of weights can be evaluated concurrently.

Preferably the primary module is configured to send a set of weights of the first population to each CPU in the cluster of CPUs for evaluation, and subsequently receive a fitness score from each respective CPU in the cluster of CPUs, the fitness score corresponding to the set of weights evaluated by each respective CPU. Alternatively, the primary module sends the entire population to the cluster of CPUs and the cluster then divides and distributes the sets of weights in the population amongst the CPUs within the cluster. The fitness scores may be sent from the cluster to the primary module in the form of an array or table, the array or table comprising a list of sets of weights and their corresponding fitness scores.

Preferably the primary module is further configured to send the second population to the secondary module for evaluation of the sets of weights of the second population; and the secondary module is further configured to evaluate the second population. Furthermore, the secondary module and the primary module may also be configured to repeat the process of evaluating a population an subsequently generating a next population iteratively up to an nth population, such that the nth population is configured to be generated by the primary module by applying the training algorithm to the sets of weights of the n−1th population to generate the nth population, the sets of weights of the nth population being dependent on the sets of weights of the n−1th population and their respective fitness scores configured to be determined by the secondary module; wherein n is a positive integer and n≥3.

Preferably the system further comprises a memory, wherein the primary module is configured to store at least one set of weights at the memory for transfer to a neural network for identifying a feature of an environment of a vehicle. Preferably the system is configured to store a final set of weights that is user selected or has the highest fitness score for use in the neural network.

Preferably, the system further comprises a user-interface for receiving an input from the user; the user-interface configured to: receive a user selection of a set of weights in any population; and apply a biasing factor to the fitness score for the selected set of weights, such that the selected set of weights has a greater fitness score. The user interface may be a touch-screen, button, or the like. It is to be understood that the user interface can be any conventional user interface for interacting with a computer, such as a mouse or keyboard.

Preferably, the training algorithm is an artificial evolution algorithm, wherein the primary module is configured to encode each set of weights in a population as an artificial chromosome.

The invention according to the first and second aspects discussed above is for training a neural network. The neural network is preferably for use in a method performed in a vehicle for identifying a feature of the environment. The method comprises: receiving an original image from a sensor or camera; pre-processing the original image to produce an input image; presenting the input image to a neural network; wherein the neural network is trained to classify a feature in an image presented to it, the neural network having an input layer, a hidden layer and an output layer, the output layer including three outputs: a first feedback output for selecting pixels from the input image to input at the input layer at each iteration of the neural network; a second feedback output for selecting a colour channel of the selected pixels to input at the input layer at each iteration; and a third output for outputting an output value indicative of a classification result from the neural network; obtaining the output value from the neural network; and post-processing the output value from the neural network to identify a feature of the environment of a vehicle.

The neural network may be a continuous time recurrent neural network and in particular a low resolution recurrent active vision neural network.

This method performed in the vehicle solves the aforementioned problems with DNNs in that the neural network employed by the method is a low resolution network. This means that the input layer of the neural network has a limited number of nodes that are few in comparison to the inputs of DNNs. Having few input nodes, for example, 32 to 150, means that less computing power is required and the processing time to run each iteration of the neural network is decreased. This also reduces demand on the training algorithm process, since a larger input layer requires more computations and thus time to find a solution for training the network. Furthermore, having few input nodes has the additional benefit of allowing the method to be stored and run on a system on chip or standard computer hardware that can be easily included or fitted to a vehicle. The first and second feedback outputs provide the neural network with active vision capabilities. The neural network selects and changes its own input from the input image for at every iteration based on the output values from the first and second feedback outputs. This makes the neural network adaptive, and advantageously provides results that are comparable to much more computationally demanding DNNs. The pre-processing and post-processing steps advantageously allow several unique tasks, such as image classification, road segmentation and object detection to be performed whilst maintaining the same neural network architecture. The same neural network can be used for each specific task, and only the weights in the neural network and the pre and post-processing steps need to change.

The feature that is to be identified by the above method is an object, for example a pedestrian, such that the method is for object detection. This type of method is advantageous in a vehicle, and in particular an autonomous vehicle, because objects in the environment of a vehicle could present a hazard to the vehicle or vice versa.

Alternatively, the feature to be identified by the method is a road or driving surface, such that the method is for road segmentation. This is useful in a vehicle and in particular an autonomous vehicle as it allows the vehicle to discern where it can travel to safely. The pre-processing may include splitting the original image into a plurality of smaller-sized patches, and presenting the input image to the neural network includes consecutively presenting the patches to the neural network.

An advantage of this method over presenting the entirety of the original image to the neural network is that smaller patches require less computational power and processing time to run through the neural network when compared to full sized images. This is part of the low-resolution aspect of method. By splitting the original image into patches, for example 400 patches, each individual patch is effectively classified by the network. The post-processing of these classified patches then allows the neural network to detect an object or segment a road within the environment of the vehicle, with results comparable results to DNNs, but at less computational cost.

Obtaining the output value from the neural network may include obtaining an output value for each patch, wherein post-processing the output value comprises post-processing the output value of each patch to produce a heat-map image. The heat-map image is formed by: generating a second plurality of patches, wherein each of the second plurality of patches is paired with an individual patch in the plurality of patches; filling each of the second plurality of patches with a singular pixel value based on the output value for the patch to which it is paired; and positioning each of the second plurality of patches in a heat-map image plane in the same relative position as the patch to which it is paired with respect to the image plane of the original image. Post-processing further comprises applying a segmentation or fitting algorithm to the heat-map image to identify the feature of the environment of the vehicle.

Forming a heat-map image in this way provides a visualisation of the results of the neural network for each patch fed into it. It also provides simplified representation of the original image, since each of the second patches in the heat-map image are coloured/assigned pixel value using only one colour/pixel value per patch. The simplified representation of the heat-map image, coloured/provided with pixels values that are based on the output of the neural network for each patch allows for simple processing to identify the feature of the environment of the vehicle. Fitting or segmentation algorithms can be applied quickly and effectively to the heat-map image because it is a simplified low-resolution representation. Furthermore, due to the results of the neural network being portrayed in the heat-map image, the results of the fitting or segmentation have an accuracy comparable to the accuracy of DNNs despite the low-resolution aspects of the method.

Each of the second plurality of patches may include the same number of pixels as the paired patch in the original image, but the second patch may also be a scaled down representation with fewer pixels. Optionally the size of the heat-map image and the original image are the same, such that the heat-map image can be overlaid on the original image for visualisation purposes. Alternatively, the heat-map image is formed by creating an array of values according to the output value for each patch, wherein each of the second plurality of patches is reduced to one pixel or a singular array entry before forming the heat-map image, such that the resolution of the heat-map image is much less than the resolution of the original image. Alternatively still, the heat-map image may be formed by directly replacing each patch in the original image with the second patch to which it is paired, by overwriting the pixels belonging to the patch in the original image with a pixel value based on the output of the neural network for said patch.

During pre-processing the original image is split such that the each patch of the plurality of patches has an overlapping region that overlaps with neighbouring patches with respect to the image plane of the original image, such that each patch shares some common pixel values with its neighbouring patches in the overlapping region.

This reduces the probability of misclassification by the neural network since each patch will share pixels at its periphery with neighbouring patches. This means that the specific task being performed on the original image, to identify the feature of the environment of the vehicle, is less affected by how the original image is split into patches and in particular where the borders of each patch are located.

Each of the second plurality of patches may be formed as sub-patches that are smaller than the patches, such that each sub-patch is paired with a portion of a patch. If the sub-patch is paired to a portion of a patch that is an overlapping region, the method further comprises filling the sub-patch with a singular pixel value based on the output values for the patch to which the portion belongs and the neighbouring patches that share the overlapping region. If the sub-patch is paired to a portion of a patch that is not an overlapping region, the method further comprises filling the sub-patch with a singular pixel value based on the output value for the patch to which the portion belongs.

The advantage of this relates to the discussion above. By basing the pixel value for each sub-patch based on whether the sub-patch corresponds to an overlapping region of a patch or not, the method ensures that the heat-map image is relatively unaffected by how the original image is split into patches and where the borders of each patch are located.

During the pre-processing of the original image, a colour transformation of the original image may be performed.

The colour transformation is a transformation into hue, saturation and green/magenta colour channels. This provides better and more accurate results than using RGB images. Optionally, the colour transformation may include using a plurality of edge filters.

When the output value is obtained from the neural network, the output value from the neural network is optionally averaged over a plurality of iterations. This ensures the output from the neural network is accurate. The first n iterations may be discounted from the calculation of the average output value, where n is a positive integer. This has the benefit of allowing the neural network to settle from initial exploratory oscillations before recording outputs that contribute to the final averaged output, which improves the accuracy of the output value. The pre-processing may include at least one of: scaling the original image; reducing the resolution of the original image; and reducing the dimensions of the original image to a one-dimensional array. The consequence of these features is that the original image is made smaller in size/resolution and as such is more suited to the low-resolution input of the neural network. High resolution images are not necessary when using the neural network to obtain results comparable to those of a DNN.

The method may further include presenting the input image to multiple neural networks simultaneously or consecutively, wherein each of the multiple neural networks are trained differently; obtaining the output values from each of the multiple neural networks; and post-processing each of the output values from the multiple neural networks and combining or comparing the post-processed output values to identify a feature of the environment of a vehicle.

The benefit of using multiple neural networks is that each can be trained differently with different training parameters and different weights. This allows the method to function in more complex scenarios and environments where one neural network may not necessarily provide the correct output value and thus correct classification of a feature in the environment of the vehicle. Since each of the neural networks is a neural network, it is possible to have multiple neural networks without compromising performance. Each network is low-resolution and thus it is feasible to have multiple networks The combining or comparing of the post-processed output values may include applying a swarm optimization algorithm to the post-processed output values to identify the feature of the environment the vehicle. When using multiple neural networks, each of which output a respective output value for each input image, it is beneficial to apply a swarm optimization algorithm to determine an overall output value. This can be done before the post-processing steps, in which case the post-processing focuses on the overall output value. However, it is more preferable that each network produces its own output value and each of these output values undergo their own post-processing. For example, multiple heat-map images may be formed based on the multiple output values. Once fitting or segmentation algorithms are then applied, swarm optimization can be used to best determine the overall feature identified by the method, rather than the overall output value.

The method may further include controlling the speed and/or direction of the vehicle based on the identified feature. For example, if an object is detected in the direction of travel of the vehicle, the speed and direction may be controlled to avoid said object. Similarly, if the centre of the road is identified in a direction that is different to a current direction of travel, the speed and/or direction of the vehicle may be controlled to redirect the vehicle towards the centre of the road. A benefit of this feature is that the method can be integrated and used in an autonomous or driver-assisted vehicle system.

The method discussed above may be implemented in a perception software stack. This perception software stack may be implemented as software modules configured to be run by a processor. In particular, a computer-readable medium may be provided having instructions stored thereon, which, when executed by the processor, cause the processor to act as a perception software stack. Similarly the perception software stack may be implemented as a computer program containing executable code, which, when executed by the processor, causes the processor to act as the perception software stack. The perception software stack comprises: a first layer configured to pre-process an original image received from a camera or sensor; a second layer configured to further pre-process the original image to produce an input image; a third layer including a neural network, the third layer configured to present the input image to the neural network; wherein the neural network is trained to classify a feature in an image presented to it, the neural network having an input layer, a hidden layer and an output layer, the output layer including three outputs: a first feedback output for selecting pixels from the input image to input at the input layer at each iteration of the neural network; a second feedback output for selecting a colour channel of the selected pixels to input at the input layer at each iteration; and a third output for outputting an output value indicative of a classification result from the neural network; and a fourth layer configured to obtain and post-process an output value from the neural network to identify a feature of the environment of a vehicle.

This perception software stack advantageously performs the method discussed above. The neural network in the third layer has a continuous time recurrent neural network (CTRNN) architecture that is preferably built to be low resolution, in the form of a low resolution recurrent active vision neural network (LRRAVNN). This means that the neural network performs an iteration much quicker and more efficiently than DNNs, because it has fewer input nodes in the input layer and thus performs fewer calculations. The first layer and second layer, which prepare the original image for the neural network, and the fourth layer, which post-processes the output value of the neural network, help to make the perception software stack more accurate and reliable at identifying a feature in the environment. As with the method above, the neural network and the perception software stack as a whole can be modified to perform different tasks, such as image classification, image segmentation and object detection. The architecture of the software stack itself is the same for each of these tasks. Simply, the processes at each layer are altered to perform the different tasks. In one example, each process necessary to perform each specific task is stored in the same perception software stack, such that each of image classification, image segmentation and object detection can be performed by one perception software stack. In this instance, the perception software stack stores a group of weights for the neural network for each specific task that is intended to be run.

The first layer may be configured to perform a colour transformation of the original image into three predetermined colour channels, such as hue, saturation and green/magenta and/or edge filter colour channels.

is the second layer may be configured to perform at least one of the following to produce the input image: scaling the original image; reducing the resolution of the original image; splitting the original image into a plurality of smaller patches; and reducing the dimensions of the original image to a one-dimensional array. The first and second layers are thus configured to perform the pre-processing steps of the method discussed above.

The input layer of the neural network in the third layer of the perception software stack may comprise fewer input nodes than the number of pixels in the input image. This helps to ensure the neural network is low-resolution which allows it to function more quickly and efficiently in comparison to DNNs. Preferably the neural network comprises 150 input nodes or fewer in the input layer.

The first feedback output may comprise two feedback output nodes, wherein the two feedback output nodes are configured to output a first and a second value respectively, the first and second values indicating a starting point in the input image from which to select a next iteration of pixels in the input image to process by the neural network.

Having two output nodes configured to provide first and second values for the first feedback output is advantageous compared to using one output node because using two output nodes is more reliable and negates any error in either one of the output nodes. As such, using two output nodes provides better inputs for the next iteration of the neural network which consequently provides more accurate output values for the neural network.

The third layer may include multiple neural networks, the multiple neural networks having been trained differently. This increases the capability of the software stack to cope with complex real-world scenarios and environments which are different from the scenarios for which each neural network is individually trained. Training the neural networks differently provides a broader functionality for the perception software stack and also makes it more reliable as output values and post-processing for each neural network in the fourth layer can be combined.

The perception software stack may further comprise a fifth layer for outputting information relating to the feature of the environment of a vehicle to a control system of the vehicle. This allows the control of the vehicle to be informed by the output of the perception software stack.

The perception software stack may be implemented in a computer device. The computer device comprises a memory and a processor, the computer device configured to be fitted to a vehicle and to communicate with a camera or sensor, the processor being configured to: pre-process an original image from the camera or sensor data from the sensor to produce an input image; present the input image to a neural network stored in the memory; wherein the neural network is trained to classify a feature in an image presented to it, the neural network having an input layer, a hidden layer and an output layer, the output layer including three outputs: a first feedback output for selecting pixels from the input image to input at the input layer at each iteration of the neural network; a second feedback output for selecting a colour channel of the selected pixels to input at the input layer at each iteration; and a third output for outputting an output value indicative of a classification result from the neural network; the processor further configured to obtain the output value from the neural network; and post-process the output value from the neural network to identify a feature of the environment of a vehicle.

Each of the sets of weights and pre and post processing functions for a specific task may be stored on the memory, meaning the computer device can locally perform a variety of tasks using the neural network from within the vehicle.

The computer device may be a system on a chip (SoC), such that specialised hardware for running a DNN is not required.

The computer device may be further configured to communicate with a control computer of the vehicle. The control computer may be a computer, smartphone, tablet or a central processing unit of the vehicle, such as a computer in an autonomous vehicle.

The neural network stored in the memory may be configured to perform one or more specific tasks including image classification, object detection and road segmentation.

The computer device may include multiple neural networks, the multiple neural networks having been trained differently, the processor being configured to present the original image to the multiple neural networks.

The computer device may be configured to perform pre-processing, post-processing and presenting to a neural network locally at the computer device, such that connection to an external network outside of the vehicle is not necessary to identify the feature of the environment. This allows a vehicle comprising the computer device to function without reliance on a network connection or connectivity to other vehicles and/or servers.

The computer device may form part of a vehicle control system for fitting in or on a vehicle. The system comprises a sensor or camera; a control computer; and the computer device, wherein the computer device is configured to receive sensor data or an original image from the sensor or camera, and output an output value to the control computer based on the sensor data or original image; the control computer being configured to control one or more components of a vehicle based on the output value received from the computer device.

The control computer may be configured to autonomously control the vehicle.

The vehicle control system may further include a plurality of computer devices, each of the plurality of computer devices being configured to perform a different specific task.

There may be a vehicle that comprises the vehicle control system.

### BRIEF DESCRIPTION OF THE DRAWINGS

Examples of the invention will now be described in more detail, by way of example, and with reference to the drawings in which:

FIG. 1 is a schematic diagram of a system 100 including a perception software stack;

FIG. 2 is a schematic diagram of the perception software stack;

FIG. 3 is a flow diagram of a method 300;

FIG. 4 is a schematic diagram of a neural network 400;

FIG. 5 is a schematic diagram of the perception software stack configured to perform image classification;

FIG. 6 is a flow diagram of example images undergoing pre-processing;

FIG. 7 is a schematic diagram of the perception software stack configured to perform image segmentation and object detection according to a specific example;

FIG. 8 is a flow diagram of example images undergoing pre-processing;

FIG. 9 is a flow diagram of example images undergoing post-processing for image segmentation;

FIG. 10 is a flow diagram of example images undergoing post-processing for object detection;

FIG. 11 is a flow diagram of example images used to inform control of a vehicle based on the outcome of the perception software stack;

FIG. 12 is a flow diagram of a training method according to the invention;

FIG. 13 is a diagram of a first training system according to the invention;

FIG. 14 is a diagram of a second training system according to the invention;

FIG. 15 is a diagram of a first example of a computer;

FIG. 16 is a diagram of a vehicle control system; and

FIG. 17 is a diagram of a system for implementing a real-time, live training method according to the invention.

### DETAILED DESCRIPTION OF THE PREFERRED EMBODIMENTS

The invention described here is a method and corresponding system for training a neural network. The neural network is suitable for a perception software stack for identifying a feature in the environment of a vehicle. The perception software stack is effectively built around this neural network to use the function of the neural network to perform one or more of several specific tasks, such as image segmentation and object detection. Because the neural network is of low-resolution, it is capable of running through data and processing results much more quickly and with less computational power than conventional neural networks. The feedback capabilities of the neural network allow it to select its own inputs from the input image. This adaptive approach effectively mimics active vision in nature, selecting and analysing small parts of an image to obtain information about the image on-the-fly rather than studying an entire image in a pixel-by-pixel brute force approach. These traits of the neural network allow it to perform efficiently whilst still providing accurate results. The invention will now be described in more detail with reference to the accompanying figures.

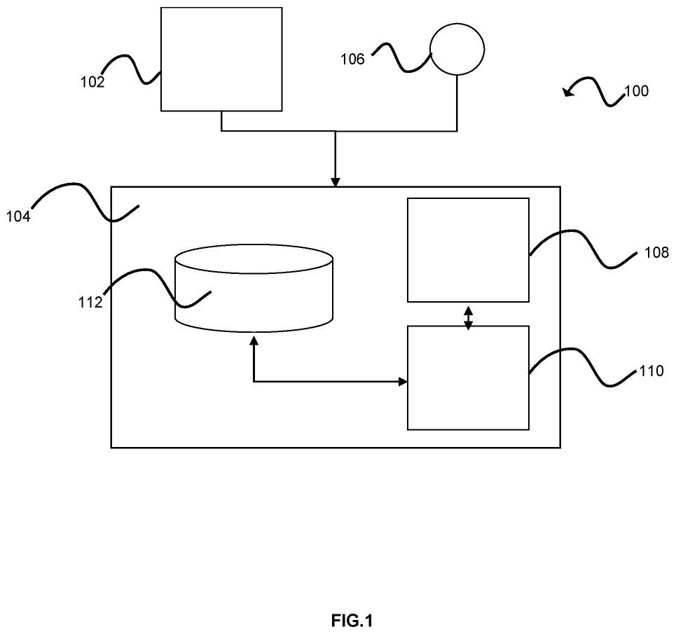

FIG. 1 is a schematic diagram of an autonomous driving system 100. The system 100 includes a training software module 102, and a computer device 104 that is configured to run a perception software stack 108.

The training software module 102 is configured to provide to the computer device 104 a set of trained weights for a low resolution recurrent active vision neural network (LRRAVNN) that forms part of the perception software stack 108. The training software module 102 generates the trained weights, for performing a specific task with the neural network, using an artificial evolution algorithm. The specific task that the weights are trained for includes one or more of image classification, image segmentation, and object detection. The specific tasks are thus computer vision tasks, the results of which are used to inform control of an autonomous vehicle. Once the process of training the weights for one or more of the specific tasks is completed by the artificial evolution algorithm, the trained weights are uploaded to the computer device 104 via a data transfer for use in the neural network in the perception software stack 108.

The computer device 104 includes the perception software stack 108 or communicates with a computer readable medium having the perception software stack 108 stored thereon. The computer device includes a processor 110 and a memory 112. The perception software stack 108 is preferably implemented as computer-readable instructions stored on the memory 112 and executable by the processor 110. The computer device 104 is configured to be fitted into a vehicle, and includes an input for connecting to a sensor 106 and an output for outputting the results of the specific task to inform control of the vehicle. The computer device may be an integrated circuit. The final weights trained by the training software module 102 are stored on the memory 112 when they are provided to the computer device 104. The memory 112 is also configured to store a configuration file, whereby the configuration file includes the operating parameters of the perception software stack 108. The operating parameters of the perception software stack 108 are different for each specific task. As such, the configuration file stored in the memory 112 is different depending on which specific task is intended to be performed by the computer device 104. The sensor 106 is configured to provide to the computer device 104 sensor data describing the environment of the sensor 106. Throughout the following description, the sensor is referred to as a camera that produces a visual image. However, it is to be understood that the sensor 106 can be a camera, infrared sensor, LIDAR sensor or the like, attached to the vehicle to which the computer device 104 is fitted. The sensor 106 is configured to send the sensor data to the computer device 104 regularly as is required by an autonomous driving system.

The sensor data provided to the computer device 104 from the sensor 106 is manipulated by the perception software stack 108. The perception software stack 108 includes a plurality of layers, including a network layer comprising the neural network. When sensor data is provided to the computer device 104, the processor 110 runs the perception software stack 108 on the sensor data based on the operating parameters in configuration file and the trained weights stored in the memory 112. The sensor data is passed through each layer of the perception software stack 108 in order, to obtain a result for the specific task being performed by the computer device 104. Once a result for the specific task is obtained, the computer device 104, using the processor 110, is configured to communicate with systems in the vehicle to aid control of the vehicle based on the result of the specific task.

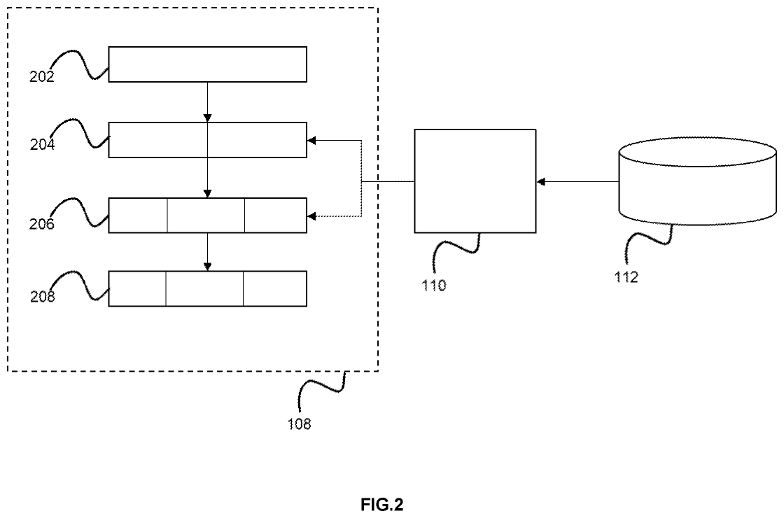

Each of the training module 102, the computer device 104 and the perception software stack 108 will now be described in more detail, with reference to their physical implementations and their associated methods of use. Firstly, the perception software stack 108 is discussed here with reference to FIG. 2, which shows a schematic diagram of the perception software stack 108. The perception software stack 108 includes a first layer 202, a second layer 204, a third layer 206, and a fourth layer 208. When sensor data, such as an image, is received by the computer device 104 from the sensor 106, it is fed into the first layer 202. The sensor data is then fed through the second, third and fourth layers in order, where it is manipulated and processed.

The first layer 202 is responsible for pre-processing the sensor data. This pre-processing is common to all specific tasks and includes a predetermined colour scheme transformation.

The second layer 204 is configured to perform further pre-processing of the sensor data, whereby the further pre-processing is dependent on the specific task being performed by the perception software stack 108. The second layer 204 is shown in FIG. 2 as being split into two sub-layers to illustrate that there are two types of further pre-processing that occur depending on the specific task being performed.

The third layer 206 is a network layer and includes the neural network that uses the weights trained by the training software module 102 for the specific task. The third layer 206 is split into three sub-layers in FIG. 2 to illustrate that the neural network has three modes of operation based on the different trained weights for each specific task.

The fourth layer 208 is configured to post-process the results outputted by the neural network for each specific task. The fourth layer 208 is similarly split into three sub-layers to illustrate that there are three different types of post-processing that can occur, one for each of the specific tasks of image classification, image segmentation and object detection.

Although FIG. 2 is illustrated with sub-layers in this way, it is to be understood that alternatively, each specific task can be provided with its own perception software stack 108, meaning that a plurality of individual software stacks exist without the need for sub-layers.

FIG. 2 also shows the processor 110 and the memory 112. The processor 110 is used to run the perception software stack 108, and the memory 112 is used to provide the perception software stack 108 with the operating parameters from the configuration file and the trained weights, dependent on the specific task to be performed.

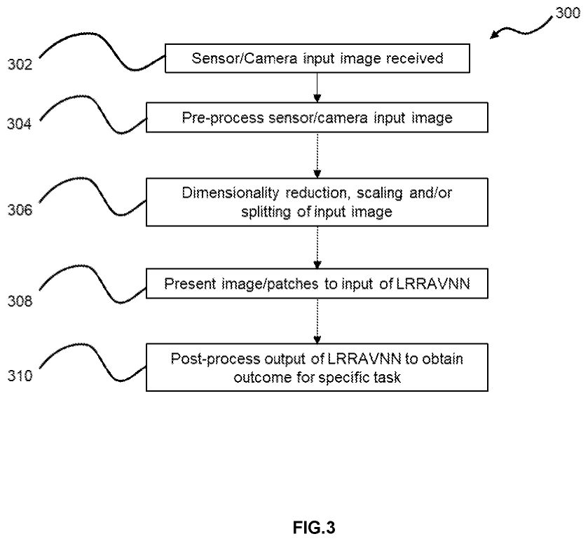

FIG. 3 shows a flow diagram of a general method 300 that incorporates use of the perception software stack 108. At step 302, a sensor/camera input is received. The input is an image such as a frame from a video.

At step 304, the image received from the sensor/camera is pre-processed at the first layer 202. The pre-processing of the image includes performing a colour conversion from the native colour scheme of the image, for instance RGB, to a HSa* colour scheme. The HSa* colour scheme includes a hue chancel (H) 224, a saturation channel (S) 226, and a green/magenta channel (a*) 228. The conversion of the colour scheme aids the performance of the LLRVANN with respect to the image when performing the specific task. Alternatively, other colour schemes may also be used. One option is to use an edge filter on the received image and use the gradient filtered output as a colour channel itself. Different types of edge filter may be used to form three different colour channels in this way.

At step 306, the image undergoes further pre-processing at the second layer 202. This involves dimensionality reduction and resolution adjustment to generate an input image for presenting to the neural network. Exactly how the image is reshaped and scaled is dependent on the specific task to be performed by the neural network. In general, the original image undergoes dimensionality reduction to produce a one-dimensional array for each colour channel. The further pre-processing in this step also includes either reducing the resolution and thus the size of the image, or splitting the image into multiple smaller images called ‘patches’, such that the size of the input image or images produced in step 306 conform with the input size requirements of the neural network.

At step 308, the input image generated in step 306 is presented to the neural network in the third layer 206. The neural network processes the input image, or images if the image was split into patches in step 306, using the weights trained for the specific task that is being performed, for a maximum number of iterations T. The neural network selects pixels from the input image using two image selection output neurons and a colour channel selection output neuron.

For each input image, an output score is produced by the neural network and outputted for post-processing by two further output neurons.

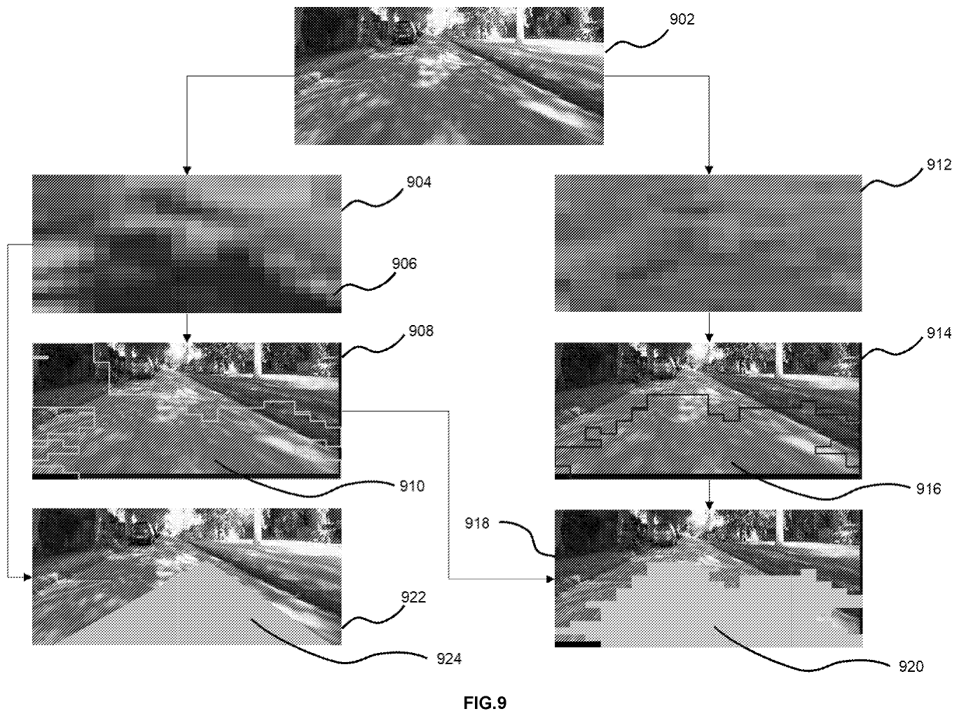

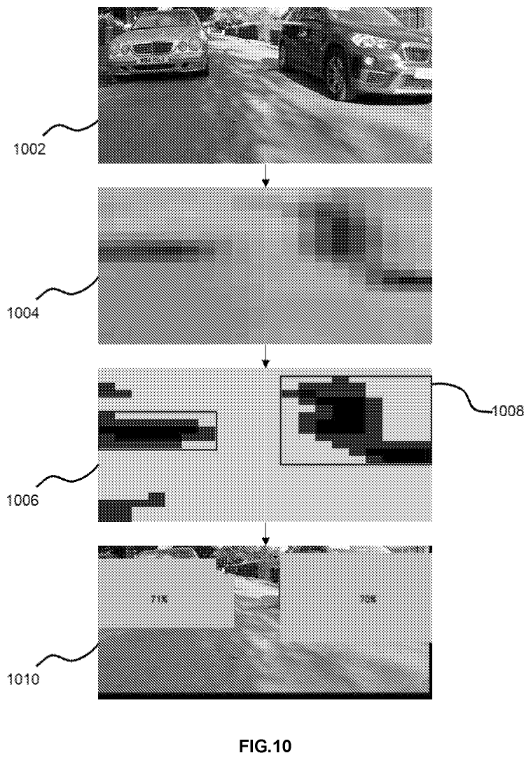

At step 310, the outputted result from the neural network in step 308 undergoes post-processing at the fourth layer 208. The post-processing step is different depending on the specific task being performed by the neural network. Examples of post-processing are provided with reference to FIGS. 9 and 10 where each specific task is discussed in more detail. The post processing step manipulates the output score from two further output neurons to determine an outcome for the specific task with respect to the input image. The outcome of the specific task is then used to inform control of the vehicle in which the system 100 and method 300 are used.

The method 300 described above refers to a single neural network. However, a plurality of k neural networks, where k is a positive integer, can be used to perform a specific task. When k neural networks are used to perform the same specific task, the output scores produced by the k neural networks are combined and post-processed together in step 310 as will be discussed in more detail below with reference to the specific tasks. Having k neural networks produces more reliable results.

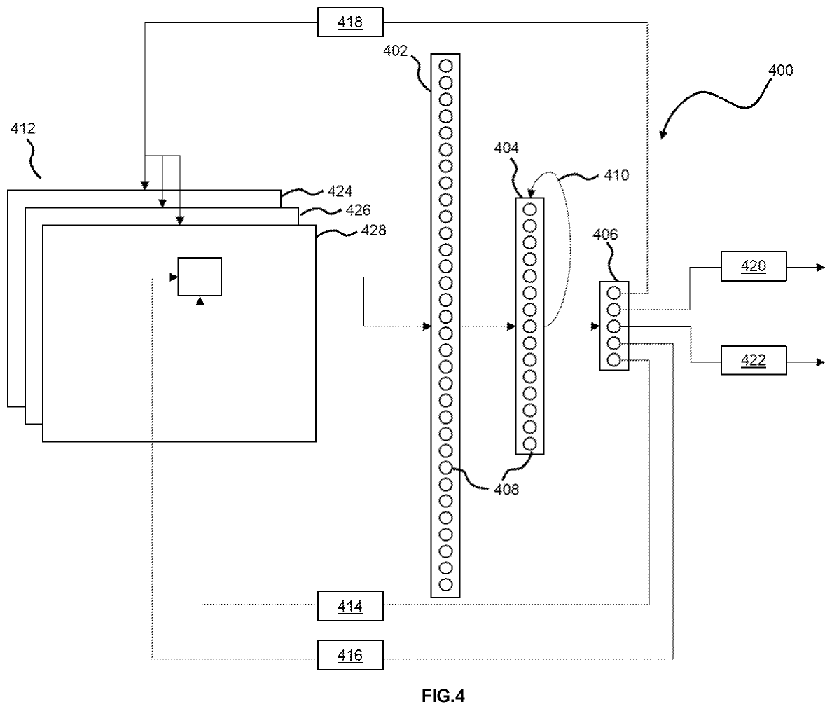

Before the specific tasks are described, the architecture of the neural network included in the third layer 206 of the perception software stack 108 will be described here with reference to FIG. 4. The neural network 400 has a continuous time recurrent neural network (CTRNN) architecture. The CTRNN architecture has an input layer 402, a hidden recurrent layer 404 and an output layer 406. Each of these layers include a plurality of neurons 408, otherwise known as nodes or processing units. These neurons connect to each other via a set of weighted connections 410. The weighted connections 410 have a weight wⱼᵢ which determines the influence of neuron ion the neuron j. The weighted connections 410 are provided with the trained weights for the specific task that is intended to be performed. Each input neuron in the input layer 402 is connected to all hidden neurons in the hidden layer 404, and each hidden neuron is connected to all other hidden neurons including itself and to all output neurons in the output layer 406. Each neuron has a transfer function that determines how the inputs from other neurons are integrated, and an activation function that determines the output the neuron produces. For the input layer 402 the value of each neuron, yᵢ can be described by equation Eq. 1 below, where I is the pixel input value, i is in the range of 1 to the total number of input neurons numinput, and g is a sensor gain value:

yᵢ=g×Iᵢ Eq. 1

For the hidden layer 404 the value of each neuron can be described by equation Eq. 2 below, where i is in the range of 1 to the total number of hidden neurons numhidden, deltaᵢ is a decay constant, and yᵢ^{cp} is the cell potential of the i^{th} hidden layer neuron:

$${delta}_{i} \times {y}_{i}^{cp} = {\sum }_{j = 1}^{numinput} {w}_{ji} \times sigmoid ( {y}_{j} + {bias}_{j} ) \qquad Eq . 2$$

For the output layer 406 the value of each neuron, yᵢ can be described by equation Eq. 3 below, where i is in the range of 1 to the total number of output neurons numoutput:

$${y}_{i} = {\sum }_{j = 1}^{numhidden} {w}_{ji} \times sigmoid ( {y}_{j} + {bias}_{j} ) \qquad Eq . 3$$

The neural network 400 has 32 input neurons in the input layer 402, 15 hidden neurons in the hidden layer 404, and 5 output neurons in the output layer 406. However, the neural network 400 may have more or less neurons at each layer. The neural network 400 has a maximum of 150 input neurons, to ensure that computational load is maintained at a low level and that the low-resolution aspect of the neural network 400 is maintained.

The neural network 400 is configured to iteratively process an input image 412. The input image 412 is the colour channel set of one-dimensional arrays that are produced by feeding a camera-captured image or other sensor data through the first 402 and second layers 404 of the perception software stack 108. The neural network 400 processes the input image 412 for a number of iterations up to a maximum iteration value T. At each iteration, pixel values from the input image 412 are processed by the neural network 400. The 5 output neurons include two image selection output neurons 414 and 416 for selecting co-ordinates of pixels in the image 412 to process with the neural network 400 at each iteration, a colour channel selection output neuron 418 for selecting one of three colour channels 424, 426 and 428 of the image 412 to process with the neural network 400 at each iteration, and two output prediction neurons, 420 and 422. The image selection output neurons 414 and 416 and the colour channel selection output neuron 418 are thus feedback outputs that are configured to modify the input to the input neurons at the input layer 402. This represents the active vision mechanism of the neural network 400. The output prediction neurons 420 and 422 provide an output score relating to the specific task that the neural network 400 is configured to run. Each of the output neurons 414, 416, 418, 420 and 422 output a value between 0 and 1.

The specific tasks will now be described with reference to the perception software stack 108, the method 300 and the neural network 400.

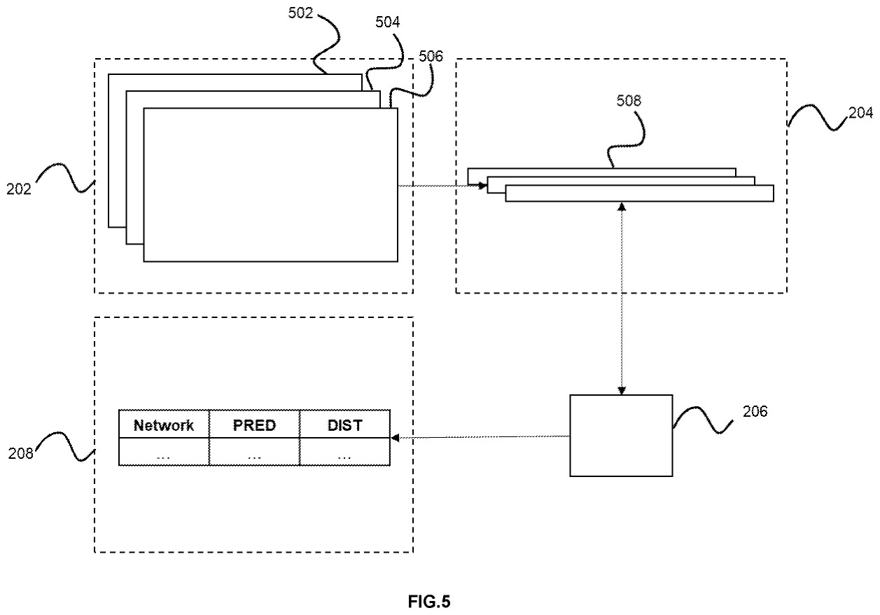

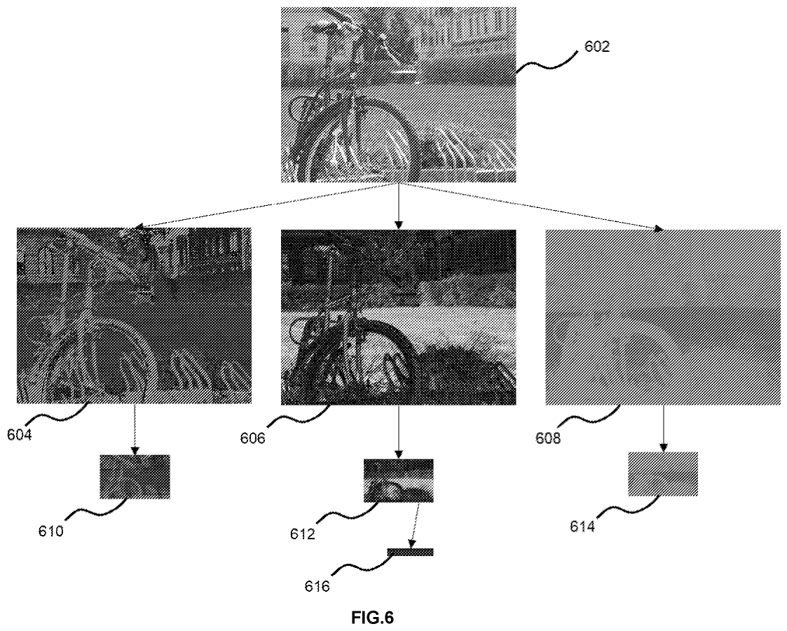

The specific task of image classification is described here with reference to FIGS. 5 and 6. Classification is the core task upon which other tasks such as road-segmentation and object detection are based. Classification is the process of classifying a whole image into a class from a range of possible classes, such as ‘bike and car’ (class 1) or ‘neither bike nor car’ (class 2). There may be a plurality of classes.

FIG. 5 is a flow diagram that illustrates the functionality of the perception software stack 108 when performing the specific task of image classification. The first, second, third and fourth layers 202, 204, 206 and 208 are illustrated as functional boxes in FIG. 5. Initially, the sensor 106 supplies sensor data such as an image from a camera to the first layer 202. Once this image is received by the first layer 202, the received image is converted into an appropriate colour scheme by the first layer 202 of the perception software stack 108, such as HSa* as discussed above in step 304. The HSa* colour scheme is made up of an H colour channel image 502, an S colour channel image 504 and an a* colour channel image 506. Each of these colour channel images are scaled down by the second layer 204 from their original size to lower-resolution images. For example, the original image may be 1280×720 pixels and is then converted to a smaller image of 64×40 pixels. The dimensions of the colour channel images are also reduced in the second layer 204, from two-dimensional images to one-dimensional arrays 508. As such, when performing the task of classification, the original image is scaled down and converted into a one-dimensional array of pixels for each of three colour channels, to form the input image 212 for processing by the neural network 400. It is to be understood that the colour conversion and the reduction of dimensions of the original image may occur in any order, meaning the position of the first 202 and second layers 204 in the perception software stack 108 are interchangeable.

FIG. 6 shows how an example image 602 is processed by the first layer 202 and the second layer 204 of the perception software stack 108 when performing image classification. The example image 602 is firstly converted from its native RGB colour scheme to the HSa* colour scheme in the first layer 202. This produces three colour channel images: a H image 604, an S image 606, and a a* image 608. Each of these colour channel images are then further pre-processed in the second layer 204 to reduce the resolution of these images and therefore their size. A reduced H image 610 is processed from the H image 604, a reduced S image 612 is processed from the S image 606, and a reduced a* image 614 is processed from the a* image 608. Although the reduced images are shown as being two-dimensional in FIG. 6, this is for illustrative purposes only. In reality, the reduced images are processed further to form the one-dimensional arrays 508 for each colour channel.

Referring back to FIG. 5, once the one-dimensional colour channel images 508 are formed by the second layer 204, they are presented to the neural network 400 in the third layer 206. The image selection output neurons 214 and 216, responsible for selecting the co-ordinates of pixels in the one-dimensional array of pixels to process at each iteration, select the pixels for each iteration according to a calculation based on two variables IN_MULT and numinput. These variables are set according to the size of the one-dimensional array and the number of input neurons in the neural network 400 respectively. Continuing from the example above, numinput is the number of input neurons, which is 32. IN_MULT is set to ensure that the total range of pixels, which is 64×40=2560, are obtainable when the image selection output neurons 214 and 216 output their maximum value. In this example, IN_MULT is set to 80, because 80×32 is 2560, the maximum pixel index value. Making these variables dependent on the size of the scaled down image allows the neural network to iterate over all possible pixels in the one dimensional array. A start position, Start_pos, that designates a pixel index for selecting pixels from for the present iteration is calculated using:

Start_pos=(OUT1×(IN_MULT))×(OUT2×numinput)−c Eq. 4

where OUT1 is the value outputted by a first of the two image selection output neurons 214, OUT2 is the value outputted by a second of the two image selection output neurons 216 and c is the number of input neurons (and thus the number of pixels processed by the neural network 400 at each iteration). OUT1 and OUT2 are between 0 and 1. This equation is limited at the low-end by applying the conditional equation:

If Start_pos<0 then Start_pos=0 Eq. 5

The neural network 400 then selects c pixels starting from the pixel index nearest to the numerical value Start_pos. In the above example, the neural network 400 selects 32 pixels in this manner, illustrated in FIG. 6 as the string of pixels 616. The two equations Eq. 4 and Eq. 5 allow for the entire of the one-dimensional array to be iteratively scanned, according to different values of OUT 1 and OUT2. It is to be understood that one of output values OUT1 and OUT2 can be replaced by a constant numerical value between 0 and 1 or removed entirely, such that the selection of pixels in the one dimensional arrays is only dependent on one of the two image selection output neurons 214 and 216. However, it is preferable to include both values OUT1 and OUT2 to reduce the individual reliance on each of the image selection output neurons 214 and 216. Using both of OUT1 and OUT2 is more reliable.

The colour channel selection output neuron 218 outputs a value OUT3 responsible for selecting the colour channel of the input image 212. The value OUT3 is between 0 and 1.

The specific colour channel is selected according to the following logic:

if OUT3<0.33 select H channel;

if 0.33<OUT3<0.66 select S channel;

if OUT3>0.66 select a* channel Eq. 6

Once the pixels from the one-dimensional arrays of pixels and the colour channel have been selected, the selected pixels are processed by the neural network 400. The output neurons 220 and 222 each output an output score OUT4 and OUT5 respectively, between 0 and 1. For each iteration the neural network 400 runs, an iteration output prediction value it_pred_val is stored, where:

it_pred_val=OUT4−OUT5 Eq. 7

Once the number of iterations is equal to T, the maximum number of iterations, a final prediction value final_pred_val is calculated by averaging the stored iteration output prediction values it_pred_val across all the iterations. This gives a final prediction value final_pred_value between −1 and +1.

Preferably, in the above calculation of the final_pred_val, the first ten iterations run by the neural network 400 are discounted to allow the network to settle, such that the it_pred_val values are averaged over the iterations after the first ten iterations. This means that the total number of it_pred_val values used in the calculation of the final_pred_value is equal to T−10.

The final prediction value final_pred_value then undergoes post-processing in the fourth layer 208 of the perception software stack 108. At this stage, two variables are calculated. These include a discrete predicted outcome, PRED, and a numerical confidence measure DIST that defines the distance from one of two confidence level thresholds, UP_LIMIT and LOW_LIMIT. The two confidence level thresholds UP_LIMIT and LOW_LIMIT may be set to any value between −1 and 1. For example, the UP_LIMIT and LOW_LIMIT may be +0.2 and −0.2 respectively. For classification tasks, PRED denotes the class that the processed image is predicted to belong to. DIST is a measure used to determine the overall class where more than one neural network 400 is used to process the input image or patches. PRED and DIST are calculated according to the following logic in this instance:

| | |
|---|---|
| if: final_pred_value > UP_LIMIT: | Eq. 8 |

```
  PRED = class 1;
    DIST = |(final_pred_value − UP_LIMIT)|;
if: final_pred_value < LOW_LIMIT:
  PRED = class 2;
    DIST = |( final_pred_value − LOW_LIMIT)|;
else: PRED = Neutral, DIST = |( final_pred_value − UP_LIMIT)|
```

In other words, if the final_pred_value from the neural network 400 is greater than the upper threshold, it is determined in step 310 that the processed image belongs to class 1. If final_pred_value is lower than the lower threshold, it is determined that the processed image belongs to class 2. If final_pred_value is somewhere between the upper and lower thresholds, then the class is labelled as neutral, meaning it neither definitively belongs to class 1 or class 2.

The variable DIST is used when there are k neural networks performing the classification task. When k networks are performing classification, the PRED values for each network are accumulated. For example, if there are 20 networks, there may be 14 instances of PRED=class 1 and 6 instances of PRED=class 2. This equates to 70% of the 20 networks producing a PRED=class 1 result and 30% of the 20 networks producing a PRED=class 2 result. These percentages are calculated and compared to a class threshold value, class_thresh. If the percentage associated with a particular class is higher than the class_thresh, it is determined that the processed image belongs to that particular class. For example, if class_thresh is 60%, then a determination is made that the image belongs to class 1, because 70% of the 20 networks produced a PRED=class 1 result, and 70% is greater than the threshold of 60%. However, if a percentage associated with a class does not exceed the class_thresh, the class of the image is not immediately apparent and the DIST variable is used instead. In this case, the class of the image is determined based on a value FIN_DIST, wherein FIN_DIST is calculated for each class using:

$$FIN\_DIST ( class ) = {\sum }_{n = 1}^{n = k} PRED ( class ) + z {\sum }_{n = 1}^{n = k} DIST ( class ) \qquad Eq . 9$$

where z is a scaling factor that is a positive real number. For example, assume that there are six networks such that k=6, where the PRED and DIST values for each network are as provided in Table 1 below:

TABLE 1

| Network | PRED | DIST |
|---|---|---|
| Network 1 | Class 1 | 0.8 |
| Network 2 | Class 1 | 0.2 |
| Network 3 | Class 1 | 0.1 |
| Network 4 | Class 2 | 0.8 |
| Network 5 | Class 2 | 0.1 |
| Network 6 | Class 2 | 0.4 |

FIN_DIST for class 1 is calculated using the sum of instances of PRED=class 1, added to the scaling factor multiplied by the sum of DIST values when PRED=class 1. As such, the value of FIN_DIST(class 1) is equal to (1+1+1)+z(0.8+0.2+0.1), which is equal to 3+1.1z. FIN_DIST for class 2 is calculated using the sum of instances of PRED=class 2, added to the scaling factor multiplied by the sum of DIST values when PRED=class 2. As such, the value of FIN_DIST(class 1) is equal to (1+1+1)+z(0.8+0.1+0.4), which is equal to 3+1.3z. The class with the largest FIN_DIST value is determined to be the class to which the image belongs. In the above example, this is class 2. This classification result output by the specific task of classification to inform the control of an autonomous vehicle. A confidence value is also outputted, whereby the confidence value is proportional to the DIST term in equation Eq. 9. Classification can be used in autonomous driving to identify the current environment, such as an urban road, a residential road, or high-street for example. Classification can also aid in identifying landmarks in the visual field, such as a bank or supermarket building that is present in the input image. Furthermore, classification can aid in identifying visible junctions and intersections. Thus the neural network can help classify if the current input image requires a right turn, left turn or straight ahead motion from the vehicle.

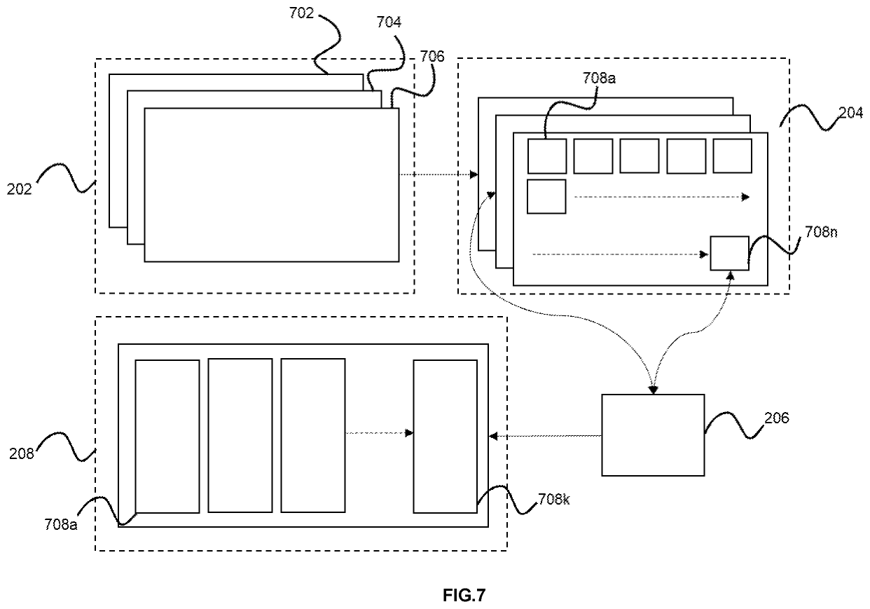

The specific task of image segmentation, and in particular, road segmentation, is described here with reference to FIGS. 7 to 9. Road segmentation is the process of separating free road space in an image from areas that are not free road space. This can be visualised by overlaying a segmented triangular shape that denotes road freespace on the image. Road segmentation thus helps to identify the boundaries of where an autonomous vehicle can safely move to. Road segmentation is applied using a very similar method to the specific task of classification as discussed above. Where classification aims to assign a class to a whole image, road segmentation involves dividing a whole image into patches, effectively classifying the individual patches, and then segmenting the whole image based on the classification of the patches.

FIG. 7 is a flow diagram that illustrates the functionality of the perception software stack 108 when performing the specific task of image segmentation. The first, second, third and fourth layers 202, 204, 206 and 208 are illustrated as functional boxes in FIG. 7. Initially, the sensor 106 supplies sensor data such as an image from a camera to the first layer 202. The function of the first layer 202 for image segmentation is identical to its function with respect to image classification. The received image is thus converted into the HSa* colour scheme in the first layer 202 of the perception software stack 108. The HSa* colour scheme is made up of a H colour channel image 702, an S colour channel 704 image and an a* colour channel image 706, as shown in FIG. 7.

At the second layer 204 of the perception software stack 108, the further pre-processing differs for image segmentation when compared to classification, in that the colour channel images 702, 704 and 706 are each divided into a plurality of patches 708a to 708n. The patches 708a to 708n have a configurable size, such as 64×40 pixels for example, and stride, depending on the original image size and the input size requirements for the neural network. The patches 708a to 708n are extracted from the original image using the following logic, considering a patch of width P_{w}, a height of Pₕ, horizontal stride Stₕ, vertical stride St_{y}, where P_numₕ and P_numᵥ are the total number of patches in the horizontal and vertical directions respectively. The first patch is extracted from the top left corner of the image plane, from the 0^{th} row and 0^{th} column of the rows and columns of pixels in each of the colour channel images 702, 704 and 706. The second patch is extracted from the 0^{th} row, and the 0^{th} column+Stₕ. The third patch is extracted from the 0^{th} row and the 0^{th} column+2Stₕ. This process repeats until the rightmost image boundary is reached or until P_numₕ is exceeded. In other words, patches are taken along the first row of pixels of the colour channel images 702, 704 and 706 from left to right, incrementing by the horizontal stride Stₕ until the rightmost boundary of the colour channel images 702, 704 and 706 are reached. Once patches have been extracted from the 0^{th} row, extraction is shifted to the 0^{th} row+Stᵥ, wherein the process repeats, extracting patches from left to right until the rightmost boundary of the colour channel images 702, 704 and 706 are reached or P_numₕ is exceeded. This process continues to the 0^{th} row+2Stᵥ and onwards until P_numᵥ is exceeded, or the bottom-right corner boundary of the colour channel images 702, 704 and 706 are reached. As an example, P_{w} may be 64, Pₕ40, Stₕ 30, Stᵥ 13, P_numₕ 20 and P_numᵥ20, giving 400 patches for a colour channel image of size 640×300. Different values for these variables can result in spaces between consecutive patches or overlapping consecutive patches. Each patch is further reduced to a one-dimensional array of pixels (not shown in FIG. 7) in the same way as is done in image classification. It is to be understood that the creation of patches can be performed before the colour conversion into the HSa* colour scheme, such that the original image from the sensor 106 is divided into patches, before the patches are converted into the HSa* colour scheme. In other words the first 202 and second layers 204 and their functions are interchangeable as is the case in image classification.

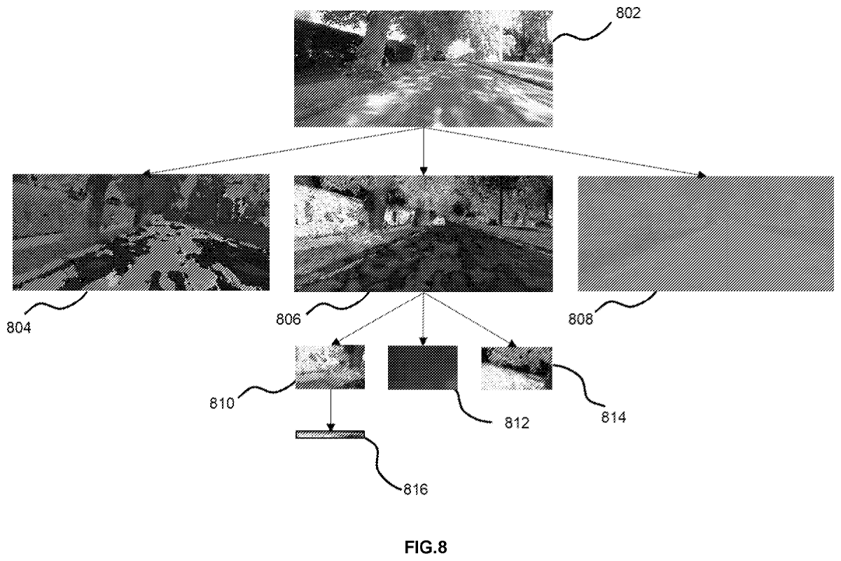

FIG. 8 shows how an example image 802 is processed by the first layer 202 and the second layer 204 of the perception software stack 108 when performing image segmentation. The example image 802 is firstly converted from its native RGB colour scheme to the HSa* colour scheme in the first layer 202. This produces three colour channel images: a H image 804, an S image 806, and a a* image 808. Each of these colour channel images are then further pre-processed in the second layer 204 to form patches for each colour channel image. FIG. 8 shows three exemplary patches 810, 812 and 814 of the S image 806. Although the patches are shown as being two-dimensional in FIG. 8, this is for illustrative purposes only. In reality, the patches are stored as one-dimensional arrays for each colour channel.

Referring back to FIG. 7, once the one-dimensional arrays corresponding to the patches are formed by the second layer 204, they are iteratively presented to the neural network 400 in the third layer 206 of the perception software stack 108. Starting with the first patch, and for each patch generated by the second layer 204, the neural network 400 performs the same processes as discussed above with respect to the specific task of image classification, processing c pixels from a string of pixels 816 based on the values of OUT1 to OUT3 and equations Eq. 4 to Eq. 7 to produce a final prediction value final_pred_val, for each patch, calculated by averaging stored iteration output prediction values it_pred_val across T iterations for each patch. The difference between road segmentation and classification at this stage is that the neural network 400 has differently trained weights and repeats processing to classify each individual patch rather than the image as a whole.

Post processing occurs in the fourth layer 208 of the perception software stack 108. The post-processing in road-segmentation can be performed in a similar way to image classification, in which the discrete predicted outcome, PRED, and the numerical confidence measure DIST are calculated according to equation Eq. 8 for each image patch. In the road segmentation task, class 1 and class 2 refer to road/non-road classes.

The variable DIST is used when there are k neural networks performing the road segmentation task. When k networks are performing classification, the PRED values for each network are accumulated as in the classification task, and FIN_DIST is calculated for each class using equation Eq. 9. The class with the largest FIN_DIST value is determined to be the class to which the first patch belongs. This process of classifying an individual patch is then repeated for all patches.

More preferably, once the final prediction value final_pred_value is calculated for each patch, it is normalized between 0 and 1, and preferably multiplied by 255, to form a heat map pixel value. For example, when the final_pred_value is −0.5, it is normalized between 0 and 1 to become 0.25, may then be multiplied by 255. As such, each patch is assigned a heat map pixel value between 0 and 255 that is proportional to its final_pred_value. The patches 708a to 708n are then reassembled on the image plane of the original image according to their respective positions in the original image, whereby all of the pixels in each respective patch are assigned the same value equal to the heat map pixel value of that respective patch. If the patches are generated in the second layer 204 such that they overlap each other in image plane of the original image, the patches are divided further into sub-patches. The sub-patches are sized such that they do not overlap neighbouring sub-patches. For example, for an original image of size 640×300, each 60×40 patch is divided into six smaller sub-patches of size 32×13. The sub-patches are then stored in a 21×22 array to provide a heat map image 708a that resembles the same image plane of the original image (not to scale in FIG. 7). When a patch is divided into sub-patches, the sub patches inherit the heat map pixel value of the divided patch. When neighbouring patches overlap in the image plane of the original image, and are subsequently divided into sub-patches, the sub-patches that are located in the overlapping portions of the neighbouring patches are designated a heat map pixel value that is the average of the heat map pixel values of the overlapping neighbouring patches. A plurality of patches may overlap in horizontal and vertical directions, meaning that a sub-patch in an overlapping portion of the plurality of patches will be designated a heat map pixel value that is the average of the overlapping plurality of patches.

Similarly, if during step 306 neighbouring patches are generated such that they are physically separated from each other in the image plane of the original image, the patches are divided into sub-patches. Sub-patches are also generated between the neighbouring patches, and are then designated a heat map pixel value that is dependent on the heat map pixel values of the neighbouring patches.

Once the patches have been reassembled on the image plane of the original image, or where there is overlap or separation of the patches on the image plane and sub-patches have consequently been generated, a heat map image 708a is produced. The further processing of the heat map image 708a is explained now with reference to an example as illustrated in FIG. 9.

FIG. 9 shows a graphical flow diagram that includes an example image 902 of a road environment captured by a camera, and a heat map image 904 that includes the 21×22 array containing sub-patches 906 that have been generated and processed with the neural network 400 as described above. The darker areas of the heat map image 904 indicate sub-patches 906 that have a heat map pixel value closer to 0, which according to the normalised final_pred_value, indicates the existence of road. The whiter areas of the heat map image 904 indicate sub-patches 906 that have a heap map pixel value of closer to 255, which according to the normalised final_pred_value, indicates non-road.

The post-processing in the fourth layer 208 of the perception software stack 108 continues, by applying segmentation or fitting algorithms to the heat map image 904. Applying a segmentation algorithm results in extracting a grid based shape from the heat map image 904. In an example, Otsu's thresholding method is firstly applied to make the heat map image 904 a binary image. A shape is then extracted from the binary image using a structural analysis algorithm such as the algorithm disclosed here:
https://www.semanticscholar.org/paper/Topological-structural-analysis-of-digitized-binary-Suzuki-Abe/cf021db5e811f5b67ee3aa4db0a6a0351d276d2

This example algorithm works on connected component analysis principles, by trying to find an outer border within a binary digitized image. All connected border shapes are first extracted. In a second pass, all ‘holes’ within the image planes are assigned scores based on their proximity to borders and filled pixels. The final pass attempts to fill in ‘holes’ depending on the their scores and adds them to existing shapes. The outermost final border is considered as the connected shape structure output.

The result of this example segmentation for one neural network 400 is shown in FIG. 9 as a segmented image 908. The segmented image 908 includes a segmented region 910 that is separated from the rest of the original image, overlaid in FIG. 9 for visualisation purposes.

It is to be understood that k neural networks can be used concurrently to produce a plurality of heat map images 708a to 708k as shown in FIG. 7. When there are more than one heat map images, the results of the segmentation process are combined. For example referring to FIG. 9, a second neural network 400 may, from the original image 902, produce the heat map image 912 and the segmented image 914 as shown in FIG. 9. The segmented image 914 of the second neural network has a segmented region 916. In this case, a combined segmented image 918 is formed from the intersection of the respective segmented regions 910 and 916, such that the combined segmented image 918 has a combined segmented region 920 that is formed of an area common to each respective segmented region of the plurality of segmented images 904 and 914. The segmented region 910, 916 and 920 is either overlaid as a visual output or the features of this shape can be used as a ‘freespace’ shape to control an autonomous vehicle.

Alternatively a fitting algorithm is applied to the heat map image 904 to produce a shape such as a triangle, whereby the area of the triangle indicates the existence of road. The triangle can be overlaid on the original image 902 to form a hybrid image 922 as shown in FIG. 9 as an alternative to the combined segmented image 918. The hybrid image 922 includes a triangle 924 indicating the existence of road. The triangle 924 can be tracked and used in the control of an autonomous vehicle. An example fitting algorithm suitable for fitting a shape such as the triangle 924 to the heat map image 904 is discussed here. Firstly a starting pixel is selected from the centre-bottom of the heat map image 604. From this starting pixel, three functions are employed to traverse pixels in the left, right and upwards directions with respect to the heat map image 604. Each of these functions compare the value of a pixel to a threshold, whereby the threshold is selected to distinguish between road and non-road values in the heat map image 904. If each function determines that the pixel above, and to the immediate left and right of the starting pixel is of a ‘road’ pixel value, the functions iteratively traverse further from the starting pixel in the upwards, left and right directions until a pixel is identified that does not have a ‘road’ pixel value. In this case it is determined that this pixel has a non-road value and as such is a boundary to the road. After boundaries are found by each of the three functions, the boundaries in the left, right and upwards direction are connected to form the triangle 924. Finally, the segmented image 908, the combined segmented image 918 and/or the hybrid image 922 are output in the specific task of image segmentation for use in controlling the autonomous vehicle. It is to be understood that ‘road’ pixel value, does not refer to the raw pixels of the input image plane. Rather, these are the intermediate pixel values assigned to the post-network processed heat map image 604.

It is to be understood that the fitting algorithm may contain thresholds for acceptable error, such that a boundary pixel is not identified until at least 1-10 consecutive pixels do not have a ‘road’ pixel value.

The specific task of object detection is described here with reference to FIG. 7 and FIG. 10. Object detection is the process of identifying specific objects such as a car or bike in sensor data outputted by the sensor 106. Object detection is initially performed in the same way as image segmentation as explained above with respect to FIGS. 7 and 8. In particular, the schematic diagram of the layers of the perception software stack 108 as shown with respect to image segmentation in FIG. 7 is exactly the same for object detection.

As with image segmentation, the process of object detection includes generating a heat map image 708a of patches or sub-patches that are each assigned a heat map pixel value according to a normalised final_pred_value calculated for each patch. In object detection, the neural network 400 is configured to classify, for example, patches that belong to an object such as a car. Therefore, the normalised final_pred_value calculated for each patch is an indication of whether or not the patch belongs to a car in the original image.

FIG. 10 shows a graphical flow diagram that includes an original example image 1002 of a road environment captured by a camera, and a heat map image 1004 that includes the 21×22 array containing sub-patches 1006 that have been generated and processed with the neural network 400 using the same processes as with image segmentation. In the heat map image 1004, the darker regions with heat map pixel values closer to 0 indicate a higher likelihood of a car being present, whilst the whiter regions with higher heat map pixel values indicate a low likelihood of a car being present. Once the heat map image 1004 is produced, the specific task of object detection differs from classification and image segmentation in that further post-processing steps are taken. In particular, three levels of thresholding are applied to the heat map image 1004, by comparing the heat map pixel value H of patches/sub-patches with the values l₁ and l₂, and updating the heat map pixel values H_{new} as described by the following logic:

if H≤l₁,H_{new}=0;

if l₁<H≤l₂,H_{new}=0.15;

else if H>l₂,H_{new}=1 Eq. 10

The variables l₁ and l₂ are user-configurable, and may be values such as 0.25 and 0.5 respectively. It is to be understood that equation Eq. 10 is exemplified by the case where the heat map pixel values are normalised between 0 and 1, however they may be in the range of 0 to 255 as described above with respect to image segmentation. The thresholding performed by equation Eq. 10 reduces the heat map image 1004 to a reduced heat map image 1006, wherein the heat patches have heat map pixel values of 0, 0.15 or 1. Patches/sub-patches with a heat map pixel value of 0 are referred to as low patches, patches/sub-patches with a heat map pixel value of 0.15 are referred to as medium patches, and patches/sub-patches with a heat map pixel value of 1 are referred to as high patches. The reduced heat map image 1006 is formed using the same image plane as the original image 1002. The reduced heat map image 1006 then undergoes further processing to produce bounding boxes 1008 as shown in FIG. 10. These bounding boxes are formed by the following logic.

Firstly, all connected shapes of low and medium patches in the reduced heat map image 1006 are identified. A connected shape comprises two or more patches/sub-patches, such that individual low or medium patches are not identified as a connected shape. Of the identified connected shapes, any connected shape with no low patches, or in other words, any connected shape consisting of solely medium patches, is disregarded. Next, the boundaries of each separate connected shape are determined as co-ordinates in the upwards, downwards, left and right directions in the reduced heat map image 1006, by determining the last connected low or medium patch in each of these directions. These co-ordinates in the reduced heat map image 1006 are then used to draw horizontal lines, from the upper and lower co-ordinates, and vertical lines, from the left and right co-ordinates, to form the bounding boxes 1008. Preferably, for each bounding box, the number of low, medium and high patches contained within the bounding box are calculated to provide a confidence value for the respective bounding box. The confidence value, Confidence for each bounding box is calculated by:

$$Confidence = \frac{2 {p}_{low} + {p}_{mid}}{{p}_{low} + {p}_{mid} + {p}_{high}} \qquad Eq . 11$$

Where p_{low}, p_{mid} and p_{high} are the number of low, medium and high patches respectively. Low patches are given a weighting of 2 in equation Eq. 11. Due to this, the Confidence may theoretically exceed 1. To prevent this from happening Confidence is limited between 0 and 1.

Once the bounding boxes 1008 have been formed and Confidence calculated, the specific task of object detection outputs the original image 1002 overlaid with the bounding boxes according to their position on the reduced heat map image 1006, for use in controlling the autonomous vehicle. This is shown as output image 1010 in FIG. 10. The confidence value Confidence is also output for each bounding box.

It is to be understood that k neural networks 200 may run the specific task of object detection concurrently, such that a plurality of heat map images 708a to 708k and 1004 and reduced heat map images 1006 are produced in the fourth layer 208 of the perception software stack 108. In this case, bounding boxes 1008 are formed for each of the plurality of reduced heat map images 1006 and corresponding confidence values calculated according to equation Eq. 11. To form the output image 1010, the bounding boxes 1008 of each reduced heat map image 1006 are combined. When bounding boxes 1008 intersect, their confidence values are averaged. Preferably, the output image 1010 is subject to further thresholding to only display bounding boxes 1008 above a certain confidence value.

Once the specific tasks of image classification, segmentation, and/or object detection are completed, the output from each specific task is used to inform the control of an autonomous vehicle. The specific tasks help to identify features of the environment of the vehicle, such as the road, pedestrians, road signs, objects, buildings, other road users, junctions and intersections and the like. Controlling an autonomous vehicle ultimately depends upon defining a ‘freespace’. Freespace is the area detected as the road, by the specific task of road segmentation, subtracted by areas within the detected road which are occupied by an object such as car, pedestrian or the like. The freespace is thus a shape formed by combining the outputs of road segmentation and object detection. Once the freespace is known, the vehicle can be controlled to navigate the freespace using standard kinematics algorithms. In particular, co-ordinate transformations are performed between the image plane showing the freespace and the three-dimensional real-world environment such that the vehicle can be controlled using standard control systems.

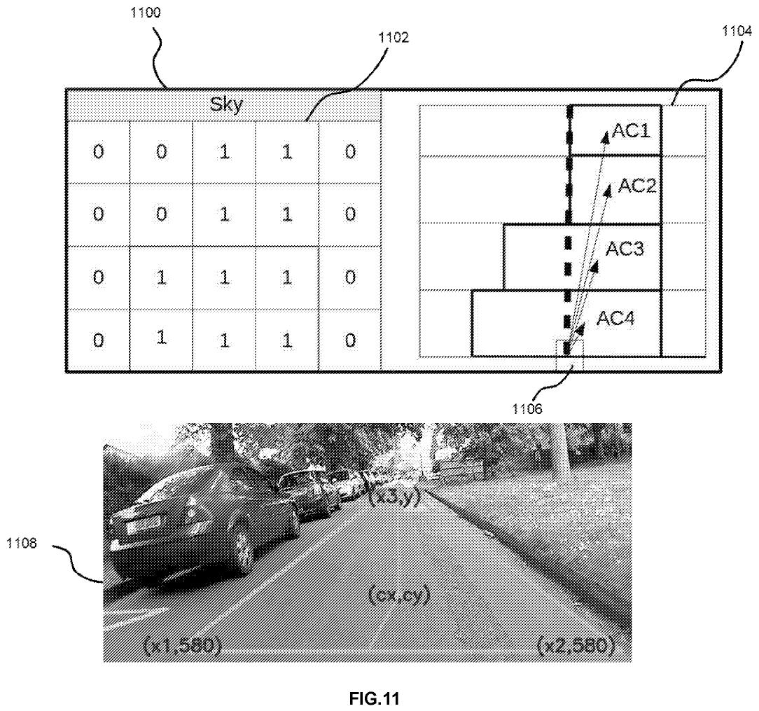

FIG. 11 shows a diagram 1100 representing the freespace shape formed by combining the outputs of road segmentation and object detection. An array 1102 represents an exemplary simplified freespace shape that corresponds to part of the image plane of an original image taken by a camera. The array 1102 is populated with a value equal to 1 where freespace is present and a 0 where freespace is not present. This array 1102 can be formed, for example, by defining the freespace as the area in the triangle 922 in the hybrid image 922, subtracted by the bounding boxes 1008 in the output image 1010.

The array 1102 is split into rows as shown in block 1104, so that the centroid C1 of the freespace shape can be calculated. Initially, the centroids AC1 to AC4 of each row are identified, as shown in FIG. 11. An arrow from the position of the autonomous vehicle 1106 with respect to the image is connected to each centroid AC1 to AC4. Where N_{row} is the number of free pixels (1 values) in each row up to a total of n rows, the centroid C1 of the freespace shape is calculated by:

$$C 1 = \frac{{\sum }_{row = 1}^{row = n} {N}_{row} {AC}_{row}}{{\sum }_{row = 1}^{row = n} {N}_{row}} \qquad Eq . 12$$

It is to be understood that other methods of calculating the centroid of the freespace may also be used, including graphical methods, such as using angular bisectors on the triangle 924 in the hybrid image 922 to form the image 1108. Once the co-ordinates of the centroid C1 of the freespace shape are calculated, various aspects of control of an autonomous vehicle can be informed using the freespace shape corresponding to an original image and other freespace shapes relating to previously processed images. For example, aspects of the autonomous vehicle relating to movement, such as speed and direction, may be informed by the location of the centroid C1 derived from consecutive image frames. Where C1ₓ and C1_{y} are the co-ordinates of the centroid C1, and C1ₓ₋₁, and C1_{y-1}, are the co-ordinates of a centroid C−1 from the immediately previously derived centroid corresponding to a previously captured original image, x_{mid} is the x-co-ordinate of the middle of the image plane of the original image, y_{threshold} is a predetermined row in the image place which serves as a cut off point for non-linear speed control and P1, D1, P2, D2 are scalar hyperparameters:

direction=P1(x_{mid}−Cₓ)+D1(Cₓ−Cₓ₋₁) Eq. 13

speed=P2(y_{threshold}−C_{y})+D2(C_{y}−C_{y-1}) Eq. 14

It is to be understood that other methods of using the calculated freespace to provide driving commands to a vehicle or computer system within the vehicle may be applied. When there are k networks which each provide their own outcome of a specific task, and thus form their own freespace shape, the method of controlling an autonomous vehicle include using combination techniques and may further include using particle swarm optimization techniques to find the optimal outcome from the k networks. For example, using combination may include averaging individual freespace centroids from each of the k networks. The centroids may be weighted differently from each other when calculating the average. Alternatively an algorithm focusing on the Coordinated Collective Behaviour Reynolds Model may be used, where alignment, cohesion and separation of the outputs of the specific task for k different networks are calculated to find the optimal outcome for the k networks. The alignment, cohesion and separation values in this swarm optimization algorithm are vectors from the position of the autonomous vehicle to the centroid of the freespace shape for each of the k networks.

Whilst the specific tasks of road segmentation and object detection have been described above in detail, it is to be understood that the general method 300 can be employed in any similar computer vision task in an autonomous vehicle, such as collision detection, road-sign detection and object tracking. In each of these tasks, a feature of the environment of the vehicle is identified, detected, determined or segmented from the rest of the environment. Each of these actions rely on the action of the neural network which fundamentally classifies an input image. The different layers of the perception software stack are modified to the requirements of each task and the training of the neural network is different based on the task. As such, the neural network is trained to classify different features dependent on the task for which it is supposed to run.

Furthermore, the application of the method 300 and the perception software stack 108 is not limited to autonomous vehicles, but can also be used in any vehicle or machine where computer vision is used. For example, the method 300 and perception software stack 108 may be used in the fields of robotics, and in neighbouring fields such as industrial manufacture, medicine, hazardous area exploration and the like. ‘Any vehicle’ refers to a vehicle where vision is required or is otherwise useful to aid the control of the vehicle. As such, vehicles includes road-vehicles such as cars, trucks and motorbikes; marine vehicles such as boats and submarines, aerial vehicles such as drones, aeroplanes and helicopters, and other specialist vehicles such as space vehicles.

It is thus to be understood that the environment in which the method 300 and the perception software stack 108 is to be used can vary. The environment may be in land, sea, air or space. Each of these environments has unique features that define the freespace area in which the vehicle is safe to navigate. On land, the features may include roads, pedestrians, hazards, objects, signage and buildings, for example. In sea and in air, the features may include weather formations, standard shipping and air lanes and hazards for example.

It is further to be understood that each of these different environments may require specialist or different sensors 106 in order to acquire sensor data that describes the environment. As such, the sensor 106 may be a radar sensor, a LIDAR sensor, a camera, a charge-coupled device, an ultrasonic sensor, an infrared sensor or the like. The sensor data received from such sensors is manipulated as explained above with reference to the ‘original image’. If the sensor provides data in three dimensions, such as the LIDAR sensor, the pre-processing steps further include dimensionality reduction to reduce the three dimensional sensor data to the one dimensional arrays before presenting said one dimensional arrays to the neutral network or networks.

It is to be understood that the method 300 and the perception software stack 108 may be implemented on any computer device or integrated circuit. Furthermore, the method 300 and the software stack 108 may be written to memory as computer-readable instructions, which, when executed by a processor, cause the processor to perform the method 300 and implement the function of the software stack 108.

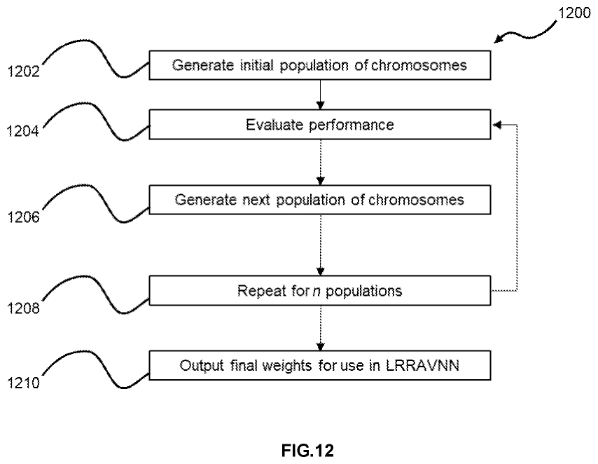

The method 300 and perception software stack 108 are adapted for each specific task through a training process, performed by the training software module 102. The training process will now be described here in more detail with reference to FIG. 12.

The purpose of the training process is to train the neural network to perform a specific task. The CTRNN and neural network architecture of the neural network does not change between the specific tasks. Instead, the weights wⱼᵢ in the weighted connections of the neural network are given values determined by the training process. These trained weights alter the calculations and thus the decision-making of the neural network so that it is adapted to perform the specific task. The general training process involves using a genetic algorithm to artificially evolve random initial weights such that, after a number of generations, they are effective at adapting the neural network to perform the specific task accurately.

FIG. 12 shows a flow diagram illustrating how the training process 1200 is performed by the training software module 102 for one neural network.

At step 1202, an initial population of chromosomes for the neural network is generated from a pseudo-random number generator function. The initial population is represented by a floating point array of Nₚₒₚ chromosomes. Each chromosome has a number of variables equal to the number of weights for the neural network N_{weights}. The weights may include a tau or decay constant and layer bias, such that they are not strictly synaptic weights from node to node. Each chromosome is an encoded/non-encoded representation of a set of weight values corresponding to the weights for the neural network. Due to the use of random number generation, each chromosome has a random initial value for each of the weights in N_{weights}.

At step 1204, each chromosome is inputted into the architecture of the neural network, such that the weight values contained in a particular chromosome are applied to the real weighted connections in the neural network. Training data such as a series of example images are then presented to the input layer of the neural network and the outputs are recorded. This occurs for each chromosome in the initial population, preferably in parallel and concurrently. The training data may be data received by an autonomous vehicle sensor, such as a radar sensor, a LIDAR sensor, a camera, a charge-coupled device, an ultrasonic sensor, an infrared sensor or the like. The performance of the initial population of chromosomes is then evaluated by applying a fitness function and recording a fitness score for each chromosome. The fitness function relates to the example images and the particular specific task that is being trained for. The fitness score provides a numerical indication of each chromosome's effectiveness at performing the specific task. As noted above, the specific tasks include image classification, object detection and road segmentation. In terms of the process performed by the neural network 400, in the specific task of image classification, the whole input image is classified, and in object detection and road segmentation, patches of the input image are classified separately. The neural network 400 therefore performs a very similar classification method for each of the specific tasks. The differences between the specific tasks are more prevalent in the post-processing steps 310 performed by the fourth layer 208 of the perception software stack 108, as discussed above with reference to FIGS. 5 to 10. In light of the similarity between specific tasks, one fitness function is suitable for training the neural network 400 to perform all specific tasks. The fitness function is defined as follows. Assume for example, there are two classes: Class 1 (1) and Class 2 (0). For each iteration of the training process, the equations Eq. 3 to Eq. 7 defined above are used to store a final_pred_value for each chromosome in the initial population. At the start of step 1204, the fitness score fitness is equal to zero for each chromosome. The fitness score fitness is reset after each population is evaluated. It effectively accumulates correct classifications of the set of example images used in the training process for each chromosome. More particularly, the evaluation at step 1204 determines whether the each chromosome can be used in the neural network to correctly classify a given set of example images, meaning the final_pred_value should be nearer 1 for Class 1 and nearer −1 for Class 2. The fitness score for each chromosome is calculated at the evaluation step 1204 for every example image in the set of example images using the following logic:

For when the true class is Class 1:

if final_pred_value>thresh_upper,fitness=fitness+1; Eq. 15

For when the true class is Class 2:

if final_pred_value<thresh_lower,fitness=fitness+1; Eq. 16

Where thresh_upper and thresh_lower are an upper and lower threshold respectively, such as 0.0.1 and −0.01. Different values of these variables affect the outcome of the training process. For further classes, such as a third class, further thresholds may be introduced. According to equations Eq. 13 and Eq. 14, the higher the fitness score, the better the neural network is at correctly classifying the set of example images. The example images may be different for training each specific task. For example, for training road segmentation, example images of roads may be provided in the training process 1200, but for object detection, example images of object such as pedestrians, bicycles and vehicles may be provided. Furthermore, if the specific task being trained for is image classification, the example images may be scaled-down images, whereas if the specific task being trained for is road segmentation or object detection, the example images may be a series of pre-defined patches.

At step 1206, the genetic algorithm is run and the next generation is created. Following the initial population, a second population of chromosomes is generated using the initial population of chromosomes and their associated fitness scores evaluated in step 1204. This involves running a genetic algorithm on the chromosomes based on their fitness scores. At least one of four operations are performed on the initial population of chromosomes to generate the second population of chromosomes. These operations include elitism, truncation, mutation and recombination. When elitism is performed, a selection of the chromosomes with the best fitness scores are replicated onto the second population without alteration. The chromosomes are thus ranked after the evaluation in step 1204 according to their fitness scores, and when elitism is applied, the chromosomes with the best fitness scores are selected. When truncation is performed, a selection of the chromosomes with the worst fitness scores are removed such that they do not form part of the second population of chromosomes. When recombination (or crossover) is performed, a new chromosome is generated for the second population by combining two or more chromosomes from the initial population. The two or more chromosomes from the initial population used to generate the new chromosome for the second generation are selected using a roulette wheel selection technique, which means that chromosomes with better fitness scores have a higher probability of being selected for recombination. The two chromosomes selected for recombination are recombined according to an operation between the two chromosomes. This may be a single, two, or k point crossover, where k is a positive real number less than N_{weights}. Other crossover operations may be used for the process of recombination. When mutation is performed, one or more of the floating point numbers in a chromosome, representing a weight, is modified by the addition, subtraction, multiplication or division of a random number. Preferably, the total number of chromosomes in the second population is equal to the number of chromosomes in the initial population, such that the number of chromosomes discarded via truncation equals the number of chromosomes introduced to the population via recombination.

At step 1208, steps 1204 and 1206 are repeated with respect to the second population of chromosomes and a new third population of chromosomes. The fitness scores are evaluated for the second population, and these are then used to generate the third population. The above process repeats, forming a new generation of chromosomes at the end of each evaluation step. This starts from the initial population and ends with the nth population, where n is a positive real number, and represents a training epoch signifying the maximum number of generations of populations.

At step 1210, the final weights are output for use in the neural network 400. It is to be understood that, whilst the above description of the training software module 102 and the method 1200 discuss one neural network, it is preferable that multiple k networks are trained using the training software module 102 and the method 1200. In this case, the initial population includes a set of k floating point arrays that are randomly generated, whereby each floating point array is configured to train one of the k neural networks.

To train the network or networks efficiently, the training software module 102 is implemented in a specific arrangement of hardware. In general, the hardware includes a primary module and a secondary module. The primary module is configured to perform the method 1200 up to and including the generation of the initial population 1202. The primary module thus defines the parameters of the training method 1200, including the number of chromosomes to be generated, the training epoch number n and the operations to be performed in the formulation of the next generation of chromosomes 1206. Once the initial population is formed in the primary module, it is sent to the secondary module. The secondary module is configured to evaluate the performance 1204 of each chromosome in the initial population. Preferably, the secondary module is configured to evaluate each chromosome in the initial population concurrently. Once evaluation of all chromosomes in the initial population is complete, a fitness score for each chromosome is returned to the primary module. At the primary module the next population of chromosomes are generated 1206 as a result of the genetic algorithm being run. The next population are then fed back into the secondary module and the process repeats until the nth generation 1208. When this generation is reached, final weights are deduced by selecting the best performing chromosomes and decoding them to determine weight values. These are then saved to a memory for transfer to the perception software stack 108.

Alternatively, when selecting the chromosomes to be saved to the memory for transfer to the perception software stack 108, re-evaluation and validation may firstly occur to ensure that the trained weight values are accurate. Re-evaluation involves, after the training process has been completed, selecting all chromosomes across all generations that have a fitness score above a specified cut-off threshold. These selected chromosomes are then re-evaluated for a different set of example images or image patches (different training data). This second example set of images is known as a validation set and ensures the accuracy of the selected chromosomes. Based on the re-evaluation, the best performing chromosomes and thus the best performing network(s) can be selected and stored.

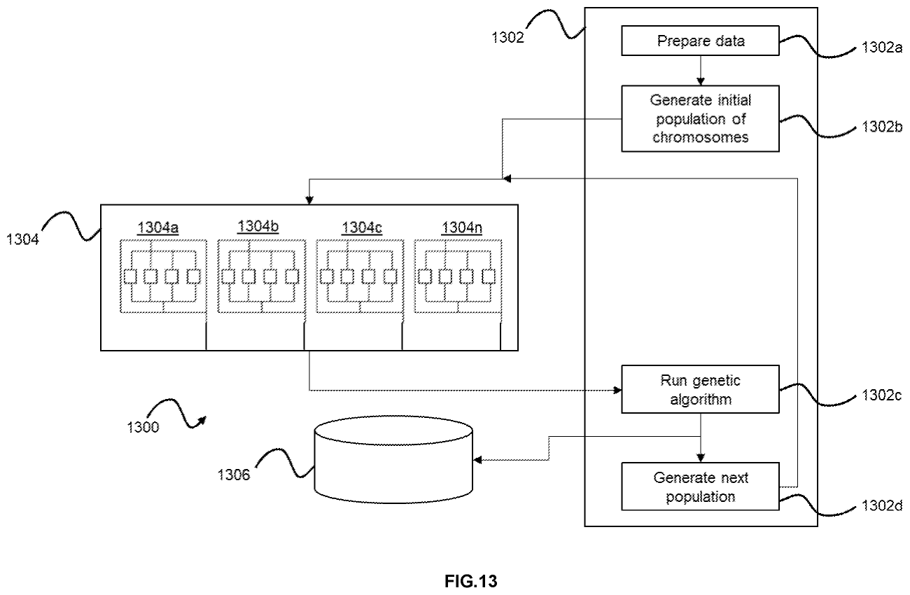

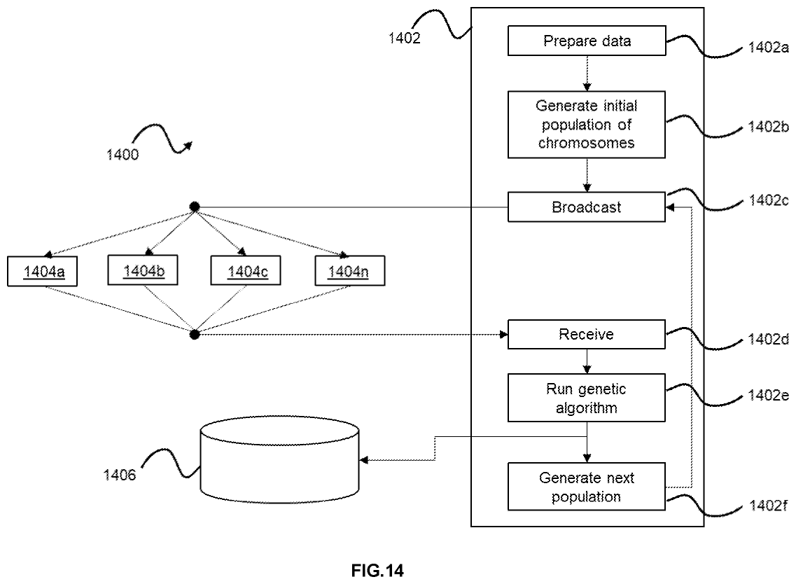

Implementations of the general configuration will now be discussed here with reference to FIGS. 13 and 14. It is to be understood that a plurality of the configurations shown in FIGS. 13 and 14 may be used to train multiple networks concurrently from different starting populations. A first embodiment of the training hardware is described here with reference to FIG. 13. FIG. 13 shows a first training system 1300 configured to implement the training process 1200 of the training software module 102. The first training system 1300 includes a central processing unit (CPU) 1302, a graphics processing unit (GPU) 1304 and a memory 1306. The CPU 1302 is illustrated in FIG. 13 including functional boxes 1302a to 1302d, relating to functions performed by the CPU 1302 during the training process 1200. The GPU 1304 includes parallel computing blocks 1304a to 1304n.

The CPU 1302 is firstly configured to prepare data 1302a for the training process 1200 by setting the parameters of the training algorithm such as the size of each population Nₚₒₚ, the number of generations n, and the operations to be used in forming each new generation as discussed above. These parameters may be read from a training configuration file. Each of object detection, image segmentation and classification have different training configuration files.

Next, the CPU 1302 is configured to generate the initial population of chromosomes 1302b. As discussed above, initially, each chromosome is a set of randomly generated weights for the N_{weights}. The initial population of chromosomes is then sent from the CPU 1302 to the GPU 1304 to be evaluated. Evaluation of each of the chromosomes is done concurrently, in parallel within the GPU 1304. The GPU 1304 evaluates each chromosome in a separate parallel computing block 1304a to 1304n. The number of blocks 1304a to 1304n is preferably equal to the number of chromosomes in the initial population Nₚₒₚ, such that each block 1304a 1304n is configured to evaluate one chromosome, corresponding to one set of weights for the neural network. Each block 1304a to 1304n is implemented using CUDA® from NVIDIA® for example. Each block comprises a plurality of threads, whereby the number of threads is equal to the number of input neurones num_input in the neural network (not shown in FIG. 13). There are hence two layers of parallelism within the GPU 1304, the first layer being the parallel-computing blocks 1304a to 1304n and the second being the plurality of threads within the blocks 1304a to 1304n. In each block 1304a to 1304n, a neural network architecture is populated with weights corresponding to the particular chromosome being evaluated. An example image is then presented to the neural network and the output recorded. The output is then used in the determination of the fitness score for the chromosome being evaluated. As this occurs in every block 1304a to 1304n concurrently, the evaluation returns a fitness score for each chromosome. For each generation, the GPU 1304 sends an array of fitness scores corresponding to the chromosomes in said generation back to the CPU 1302, for running step 1206 of the method 1200 as discussed above. In particular, functional box 1302c in FIG. 13 corresponds to the application of operations such as mutation, recombination, elitism and truncation to manipulate the chromosomes according to the array of fitness scores. Functional box 1302d corresponds to the result of these operations in generating the next population of chromosomes. These are then sent into the GPU 1304 for another round of evaluation until a last generation counter reaches the training epoch number n. Once the training epoch number n is reached, the final weights are determined or chosen according to the fitness scores of the chromosomes of the final population. Preferably, the highest ranking chromosome in terms of fitness score is selected to provide the final weights. Alternatively, the highest ranking chromosome from any generation provides the final weights. The final weights are then stored in them memory 1306. The memory 1306 may then be used to store and/or transfer the final weights to the computer device 104 for use in the third layer 206 of the perception software stack 108.

FIG. 14 shows a second embodiment of a training system 1400 configured to implement the training process 1200 of the training software module 102. The second training system 1400 includes a primary central processing unit (CPU) 1402, a cluster of secondary CPUs 1404a to 1404n, and a memory 1406. The primary CPU 1402 is illustrated in FIG. 14 including functional boxes 1402a to 1402f, relating to functions performed by the primary CPU 1402 during the training process 1200.

The primary CPU 1402 is firstly configured to prepare data 1402a for the training process 1200 by setting the parameters of the training algorithm such as the size of each population Nₚₒₚ, the number of generations n, and the operations to be used in forming each new generation as discussed above. These parameters may be read from a training configuration file. Each of object detection, image segmentation and classification have different training configuration files. Next, the primary CPU 1402 is configured to generate the initial population of chromosomes 1402b. Initially, each chromosome is a set of randomly generated weights for the N_{weights}. Following the generation of the initial population, the primary CPU 1402 is configured to broadcast 1402c the initial population of chromosomes to the cluster of secondary CPUs 1404a to 1404dn. The primary CPU 1402 is thus communicatively coupled to the cluster of secondary CPUs 1404a to 1404n. Each of the secondary CPUs may be on the same server as each other and as the primary CPU 1402, or may be located across multiple servers. Preferably, the number of secondary CPUs 1404a to 1404n is equal to the number of chromosomes in the population, Nₚₒₚ, so that each secondary CPU 1404a to 1404n can concurrently evaluate a chromosome from the initial population. The number of secondary CPUs 1404a to 1404n can however be less than Nₚₒₚ. In this case, some or each of the secondary CPUs 1404a to 1404n may be required to evaluate more than one chromosome from the population. Evaluation of each of the chromosomes is thus done concurrently or partially concurrently, in parallel by each of the secondary CPUs 1404a to 1404n. The evaluation by each secondary CPU 1404a to 1404n returns a fitness score for each chromosome. Each fitness score or scores from each secondary CPU 1404a to 1404n are then sent back to the primary CPU 1402 where they are received 1402d. An array of fitness scores may thus be formed from the fitness scores received at the primary CPU 1402. The chromosomes and their corresponding fitness scores are then run through the genetic algorithm 1402e, meaning step 1206 of the method 1200 is performed as discussed above. In particular, functional box 1402e of the primary CPU 1402 in FIG. 14 corresponds to the application of operations such as mutation, recombination, elitism and truncation to manipulate the chromosomes according to the array of fitness scores. Functional box 1402f corresponds to the result of these operations in generating the next population of chromosomes. These are then sent into the cluster of secondary CPUs 1404a to 1404n for another round of evaluation until a last generation counter reaches the training epoch number n. Once the training epoch number n is reached, the final weights are determined or chosen according to the fitness scores of the chromosomes of the final population. Preferably, the highest ranking chromosome in terms of fitness score is selected to provide the final weights. Alternatively, the highest ranking chromosome from any generation provides the final weights. The final weights are then stored in them memory 1406. The memory 1406 may then be used to store and/or transfer the final weights to the computer device 104 for use in the third layer 206 of the perception software stack 108.

It is to be understood that the determination of the final weights to be used in the perception software stack 108 may be done according to factors other than the fitness scores and ranking of chromosomes. For example, a particular chromosome may classify specific objects, such as bicycles, very effectively but other objects, such as cars, less effectively. The weights from this chromosome may still be selected as the final weights if for instance, multiple k networks are being used, whereby a network that effectively identifies bicycles is useful. In other words, the final weights may be determined based on the intended function of the neural network. Furthermore, more than one set of weights from more than one chromosome may be selected, so that more than one network can selected using the same training process 1200.

The embodiments illustrated in FIGS. 13 and 14 may also include an interface for receiving input from the user. Using this interface, the user can manually filter or give preference to particular chromosomes or networks in the training process, and can similarly select any chromosome from any generation to use as the final weights for the neural network. It is to be understood that the training process and the training system may be implemented in any computer system, including a distributed computing system such as a cloud or server based computer system. The primary module discussed above is configured to perform all the steps of the training process apart from evaluation of the sets of weights or chromosomes. The evaluation is performed by the secondary module which has parallel computing capabilities. In a distributed system, the secondary module may communicate with the primary module via a server and/or over the internet. In some embodiments, the parallel computing means (the GPU 1304 or cluster of secondary CPUs 1404a to 1404n) may be implemented as a system on a chip (SoC), or a field-programmable gate array (FPGA).

The hardware aspects of the computer device 104 will now be discussed with reference to FIGS. 1, 15 and 16. The following hardware is implemented as the computer device 104, and includes the perception software stack 108 or communicates with a computer readable medium having the perception software stack 108 stored thereon. The computer device includes a processor 110 and a memory 112. The perception software stack 108 is preferably implemented as computer-readable instructions stored on the memory 112 and executable by the processor 110. The computer device 104 is configured to be fitted into a vehicle, and includes an input for connecting to a sensor 106 and an output for outputting the results of the specific task to inform control of the vehicle. The computer device may be an integrated circuit such as a System on a Chip (SoC).

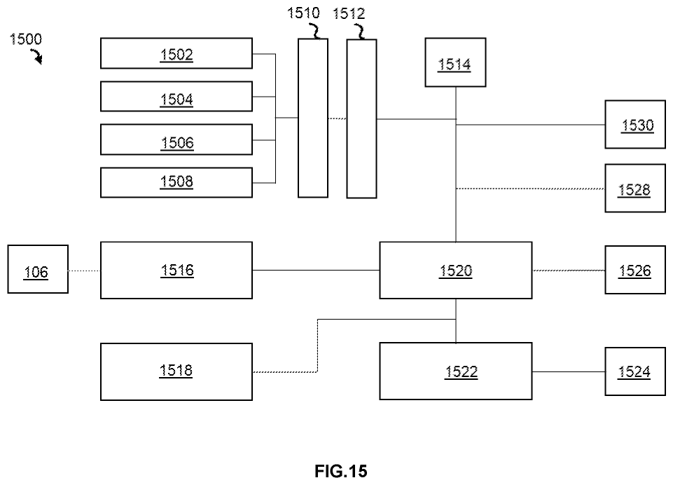

An example of the computer device 104 is described in detail with reference to FIG. 15, showing an apparatus 1500. The apparatus 1500 is configured to perform the method 300. The apparatus 1500 includes a random access memory 1502, a flash memory 1504, an External Bus Interface 1506 for interfacing external memory devices, a Flash Programmer 1508 for flashing the memory of a microcontroller, a memory controller 1510, a peripheral data controller 1512, a memory storage chip 1514 for storing the perception software stack 108, an input/output 1516 for interfacing with the sensor 106, a power in and voltage regulator 1518, a peripheral bridge 1520, one or more processors 1522, a debugger 1524, application specific logic 1526, one or more buttons and/or LED indicators 1528 and an expansion bus 1530. These components are connected as shown in FIG. 15.

It is to be understood that the apparatus 1500 is configured to perform the method 300 for one or more of the specific tasks of image classification, object detection and image segmentation. Some of the components of the apparatus 1500 may be removed or substituted with similar components as will be understood. In use, the sensor 106 provides input sensor data to the apparatus 1500 via the input/output 1516. The sensor data is then manipulated according to the aforementioned methods. The apparatus 1500 may communicate with the sensor using any suitable communication means, such as Ethernet, Universal Serial Bus (USB), serial, Bluetooth, wireless networking (Wi-Fi) and the like. The apparatus 1500 may be a SoC and may take the form of a computer, smartphone, tablet or the like. An SoC has the advantage that task specific computer programs can be written specifically for the SoC thus saving on loading time and speed. The apparatus 1500 may however be a traditional computer installed on a single motherboard.

In an example, the computer device 104 is modular, meaning the computer device 104 is responsible for performing one out of several specific tasks. There may then be a module for each of image classification, object detection, and image segmentation, formed of individual computer devices 104. Each of these devices may communicate with each other via wired or wireless connection methods and may also connect to the same or different sensors 106.

Each one or more of the computer devices 104 may connect to a network that is external to the vehicle. This allows the software stored thereon to be updated. For example, the weights stored in the memory 112 may be updated via communication with the external network. However, each of the computer devices 104 is configured to function or be capable of functioning without communication with an external network. The low resolution of the neural network allows the specific tasks to be performed on the computer device 104 without external computing aid.

Once the apparatus 1500 or computer device 104 has run the method 300 to obtain an outcome for a specific task, it is configured to send information relating to the outcome to a controller computer. The controller computer can be any computer which requires the outcome, such as a vehicle's engine control unit or another SoC. The apparatus 1500 may also store historic outcomes from specific tasks on its own memory chip 1514.

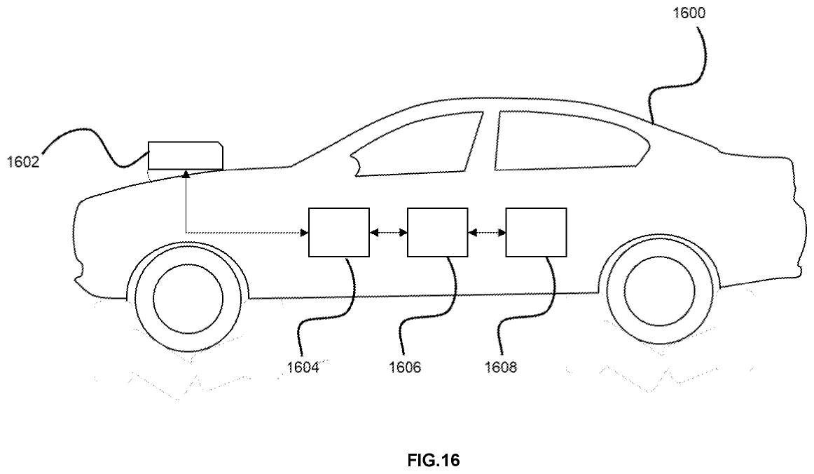

FIG. 16 shows a vehicle 1600 including the system 100. The vehicle 1600 includes one or more sensors 1602 fixed to the vehicle, an apparatus 1604 corresponding to the computer device 104 and/or the apparatus 1500, a controller computer 1606 and a vehicle component unit 1608. The apparatus 1604 includes at least a processor and memory and is configured to perform the method 300 discussed above. Once an outcome is calculated by the apparatus 1604, it is sent to the controller computer 1606. The controller computer 1606 then uses the outcome to control the vehicle 1600, by sending instructions to the vehicle component unit 1608. The vehicle component unit 1608 is a physical component or system of the vehicle 1600 that is responsible for movement of the vehicle. The vehicle component unit 1608 may thus be the engine control unit, a braking unit, a steering unit or the like. The controller computer 1606 includes at least a processor, memory and communication components for communicating with the apparatus 1604 and the vehicle component unit 1608. The controller computer 1606 is preferably configured to autonomously or semi-autonomously control movement and thus driving of the vehicle 1600. The apparatus 1604 is preferably a SoC as discussed above, and may be one of several individual apparatuses. Each of these apparatuses may communicate with each other and the controller computer 1606. Sensor data is fed from the sensor 1602 into the apparatus 1604, where it is manipulated using the method 300 and the trained neural networks, as previously mentioned. The outcome produced by the neural network in the apparatus 1604 is then sent to the controller computer 1606 where it is used to control one or more vehicle component units 1608.

It is to be understood that any conventional computing components may be used to implement the computer device 104 and the components shown in FIG. 16. However, it is preferred that the computer device 104 or apparatuses 1604 are SoC due to the speed and efficiency benefits of using a SoC design in comparison to traditional computers. Advancement in modern computing has allowed all the crucial internals that allow a computer to run to be installed on a single chip. These would include processors, input/outputs, memory controllers, storage and the like. In traditional computing these would have been managed by different components which would have to have been manually installed on a single motherboard connecting everything together. An SoC, by contrast, integrates multiple or all of these functions onto a single small board which is the same size or often smaller than a conventional CPU. Where traditionally, a computer requires the operating system first to boot up, and drivers to load, by contrast, the advantage of an SoC is that task specific computer programs can be written specifically for the SoC thus saving on loading time and speed.

The SoC also has the advantage of not needing to connect to an external network. Each of the specific tasks of image classification, object detection and image segmentation can be performed by the SoC locally in the vehicle. Furthermore, due to the low-resolution aspects of the neural networks, multiple networks can be stored in the memory of the computer device 104 or SoC. This means that swarm optimization or other collective behaviour algorithms or techniques can be applied to input data from a camera or sensor locally at the computer device 104 or SoC, without having to communicate with an external network. This saves valuable time which can improve the responsiveness and thus safety of a vehicle such as an autonomous vehicle which includes the computer device 104 or SoC.

Where multiple SoCs are used, each for a different specific task, the local nature of the calculations and functioning of the SoCs allow them to easily communicate and pool their outputs together. For example, where a first SoC is configured to perform the function of object detection, and a second SoC is configured to perform the function of road segmentation on an input image, the SoCs may communicate with each other to determine the available freespace on the road (the segmented road subtracted by any objects on the road). Alternatively this function is performed by the controller computer 1606 when it is connected to multiple apparatuses 1604.

It is not necessary that the camera/sensor 106 and 1602 be fitted to the vehicle 1600 or computer device 104. Instead, the camera/sensor 106 and 1602 may be physically separate from the computer device 104 and vehicle 1600, such that the camera/sensor 106 and 1602 is not fitted to a structure or is fitted at an external location. The external location may be, for example, at a junction on a road, on a traffic sign or on a lamppost. In this example, the camera/sensor 106 and 1602 communicates with the computer device 104 or vehicle 1600 and thus the apparatus 1604 via a network. The camera/sensor 106 and 1602 and the computer device 104 or apparatus 1604 comprise or are locally connected to network connection hardware configured to connect to a network. The network connection hardware may include any one or more of a Wi-Fi module, a cellular module, a mobile-network transmitter and receiver, an antenna, a Bluetooth module and the like. In this example, the output of the neural network in performing a specific task may be shared from the computer device 104 or apparatus 1604 to other computers or vehicles directly, or sent to a central computer on a server or network for distribution to other vehicles.

Although the description above relates to the specific example of a vehicle and in particular an autonomous vehicle, it is noted that the computer device 104 and the vehicle 1600 can alternatively be any machine where visual sensory data is gathered, manipulated or used to perform an action. As such, the computer device 104 and the vehicle 1600 may be a robot, a CCTV system, a smart device for a smart home, such as a smart speaker, smartphone or a smart appliance.

Similarly, although the description above relates to performing specific tasks related to vehicles, such as object detection, road segmentation and image classification, it is to be understood that the principles of using active vision in a LRRAVNN according to the method 300 can be applied to any computer vision task. As such, other tasks may be performed by the computer device 104 using the method 300. For example, a CCTV system using the method 300 may perform facial recognition, whilst a robot using the method 300 in a manufacturing environment may perform object classification and quality checking.

A specific embodiment of the training method will now be disclosed, providing live on-the-fly training for an autonomous vehicle. The neural network is typically pre-trained by the training algorithm, with a final set of weights stored for use in the perception software stack 108. However in this embodiment, the training algorithm can dynamically train the neural network whilst it is in use by the perception software stack 108. Training the neural network by generating a newly optimised set of weights constantly, or periodically, during use of the autonomous vehicle is beneficial, as the neural network will continue to optimise and therefore increase accuracy of image classification, image segmentation, or object recognition performed by the neural network. Accuracy of the neural network will increase, in part, due to the shear increase in the amount of training data used, when live, real-time training is performed.

Moreover, training the neural network with real-time, live data means that the neural network will be better optimised for the current real world conditions, such as weather conditions, ambient light levels, traffic conditions on the roads such as congestion or the like, and behavioural habits of pedestrians at due to external factors (e.g. weekends vs weekdays, good weather vs poor weather, or the like). For example, If it is currently raining at night time with very light traffic congestion but a high pedestrian count, the prediction of the neural network when performing the specific task will be more accurate if training data is used that is captured also during rainfall at night time with very light traffic congestion but a high pedestrian count. This is possible if live, real-time data is used.

Real-time, live data can be input into the training algorithm either through manual input by a human operator, or from an existing image filter which can send training data patches in an unsupervised manner. As before, the training data may be data received by an autonomous vehicle sensor, such as a radar sensor, a LIDAR sensor, a camera, a charge-coupled device, an ultrasonic sensor, an infrared sensor or the like. The live training data may be provided from the sensor 106 on the autonomous vehicle that the trained neural network is running on. For example, the autonomous vehicle can take an image using, a camera as the sensor 106, process the image (perform the specific task) using the perception software stack 108, control the vehicle based on the output of the specific task, for example steering the vehicle away from an obstacle, and then send (or simultaneously send) the image via a data link to the training software module 102 to be input into the training algorithm to generate a new set of weights for the neural network. Data captured by the sensor 106 to be used for real-time, live training could be selected at random, or could be periodically selected from the data captured by the sensor 106. For example, every tenth, hundredth, or thousandth image captured by the sensor could be sent to the training algorithm as the live training data.

Alternatively, the real-time, live training data may be provided from a sensor not located on the autonomous vehicle, such as a sensor at a junction on a road, on a traffic sign or on a lamppost, or the like. Moreover, the real-time, live training data could also be provided from other autonomous vehicles also currently in operation. For example if a fleet of autonomous vehicles are in use, a subset of the vehicles may be feeding back training data for real-time, live training. A resulting set of weights produced by the training may be sent to some or all of the fleet of autonomous vehicles to be used in the perception software stacks.

During the live training process, a human operator receives the real-time, live training data and categorizes or labels it, in order for the fitness score to be able to be calculated during training using the live training data. Default settings, for example, capture N number of images every 10 minutes, may be used as explained above. Alternatively the vehicle may capture data as directed by the human operator (in other words, the operator may decide when the data is captured). After live data capturing is completed the data may be displayed to the operator on a user interface (UI) that is specifically configured to display the data and allow annotation by the operator. For example, in some embodiments a touch screen may be used for the operator to manually select part of an image, or the like. Any other human-computer interface may be used to annotate the image ready for use in training the neural network for the specific task. The labelling/UI platform is configured to ease the nature of annotations such that a batch of images/patches can be efficiently labelled and sent for training by the operator. The UI platform may be an auto-grade UI display.

The human operator may use the UI during the training process to initiate recording of particular sequences of data, and to carry out labelling of the captured batch of images/patches. The training process is then performed using the captured data. In this way, the autonomous vehicle captures data on-the-fly and relays the data to the training software module 102 (via the human operator) for training of the neural network.

Constant re-training of the neural network by live training data can be heavy on computing resources. The available computing resources may therefore be taken into account when deciding how often to retrain the neural network, and how much live training data is to be used. The parallel computing performed by the GPU 1304 or cluster of secondary CPUs 1404a to 1404n described above is particularly beneficial when real-time, live training is performed. Training of the neural network can be performed in a much reduced time-scale using the parallel computing framework, and weights ready for deployment onto the perception software stack 108 can therefore be generated more quickly.

Once the training software module 102 receives the live training data, appropriate computing resources are selected. This may include a high performance computing (HPC) CPU server, or a GPU, which may be included on the vehicle in some embodiments. The training system performs accelerated training runs due to the parallel computing framework, and then returns sets of weights available for deployment in the neural network on the autonomous vehicle. In particular, the weights can be transferred to a processing unit within an autonomous vehicle or to an advanced driver-assistance system (ADAS) in the vehicle.

As before, the best performing chromosome can be chosen at the end of the training process, and the final set of weights decoded from the best performing chromosome are sent for deployment on the vehicle. A re-evaluation and validation process may occur on the best performing chromosomes, as described previously. Moreover, before transmitting a newly trained sets of weights for deployment in the neural network, a check may be performed to ensure the newly trained weights are an improvement over the existing set of weights used by the neural network. This check may include comparing the fitness scores of the new set of weights produced by the real-time, live training, and the previous set of weights used by the perception software stack. In some embodiments, the human operator may have a final input at the end of the process before deploying the newly trained weights onto the vehicle, to determine if an improvement is achieved.

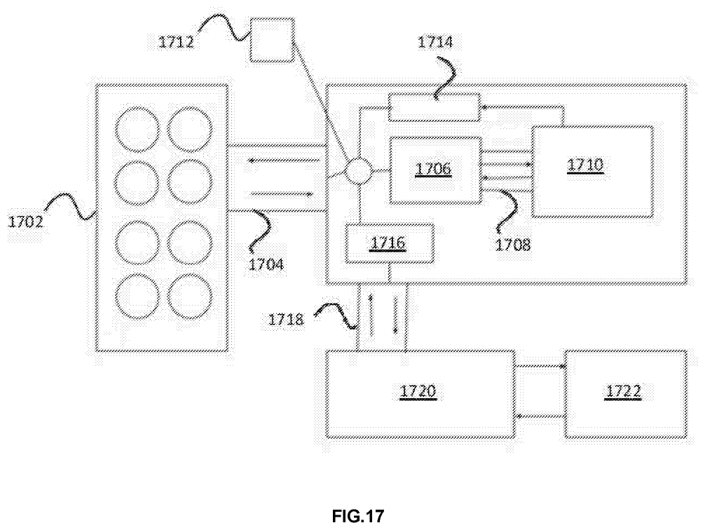

FIG. 17 shows a system for implementing the above described real-time, live training method. In particular, FIG. 17 shows the specific physical, digital and network infrastructure for facilitating execution of the real-time live training of the neural network in the case of an autonomous vehicle.

The system 1700 includes one or more sensors 1702 on an autonomous vehicle. Typically an array of sensors 1702 are used, and these sensors may include at least one of a radar sensor, a LIDAR sensor, a camera, a charge-coupled device, an ultrasonic sensor, an infrared sensor or the like. A data link 1704 allows communication between the one or more sensors 1702 and the various components within the autonomous vehicle, including the training infrastructure.

In particular, the vehicle includes a training user interface (UI) platform 1706 connected via a data link 1708 to a vehicle training server 1710 (together forming the training infrastructure). A human operator may interact with the training user interface (UI) platform 1706 when the live data is received, to process it, for example categorising or labelling it, ready for use in the training algorithm. The UI platform 1706 may include software and data-structures implemented to enable data-capture. This data capture occurs whilst the associated autonomous vehicle is in operation (real-time, live data capture). The UI platform is a human-computer-interface which may include auto-grade physical hardware (to withstand pressure/vibrations of a mobile vehicle). Moreover the display and labelling software utilities may be pre-configured for efficient labelling of the desired specific functionalities. A generalistic annotation user interface may be used, which involves marking bounding boxes with a specific format to facilitate usage across standard A.I architectures. Alternatively, the UI may be pre-configured to capture data labels in specific formats like grid-patches, pixel areas, or the like for training of the neural network.

A configuration file 1712 provides the initial settings for the training infrastructure upon start-up or for new training run. The vehicle training server 1710 is connected to a vehicle operation server 1714, for controlling the vehicle perception and/or action. The perception software stack may be implemented in the vehicle operation server 1714.

Alternatively or additionally to the training infrastructure, the vehicle further includes a vehicle network unit 1716, such as a router. The vehicle network unit 1716 allows communication between the vehicle and a remote command-hub that is separate from the vehicle. In some embodiments the remote command hub can be a cloud based server. In particular, the vehicle network unit 1716 is connected via a data link 1718 to a remote command hub training UI platform 1720 which is in turn connected to a remote training server 1722 (together forming a remote training infrastructure). Both the remote command hub training UI platform 1720 and the remote training server 1722 may be implemented virtually, and may perform the same function as the vehicle training server 1710 and training UI platform 1706.

In other words the training systems 1300,1400 of FIGS. 13 and 14 are implemented in either the vehicle training server 1710 or the remote training server 1722. Moreover, in some embodiments the operation of the training algorithm may also be distributed over both the vehicle training server 1710 and the remote training server 1722.

In the case that the training algorithm runs on the vehicle training server 1710 within the autonomous vehicle, a safety driver present in the autonomous vehicle may access the training UI platform 1706. Alternatively or additionally, the training algorithm may run on the remote training server 1722 in the remote command hub. When running on the remote training server, the training UI platform is accessed virtually by a human operator via the remote training UI platform 1720 in the command hub/monitoring center. In other words, the remote training infrastructure provides a cloud based monitoring and training system for the autonomous vehicle, in addition to, or as an alternative to, monitoring and training from within the vehicle.

When cloud based monitoring and training is used, computing inter-process communication protocols are implemented for transfer of data and neural network weights between servers on and off the autonomous vehicle during operation. Additionally, the vehicle includes data pipelines and system programs configured to update the neural network weights during operation of the vehicle.

The system 1700 allows for real time training of a neural network, which leads to a neural network better optimized to perform the specific task in real time. Moreover, the use of parallelized computing accelerates the speed of the training, making real-time live training viable, and implementing the training algorithm as a practically executable program on computing hardware. The system allows for the monitoring and/or training of the autonomous vehicle to occur in situ (in vehicle) or from a remote location. This can improve the versatility of the training system.

The system 1700 has been developed primarily for use in autonomous driving and transport applications. However the system could equally be applied to various other sectors where real-time, live training is beneficial.

1. A computer-implemented method for training a neural network, including:
generating a first plurality of sets of weights for a neural network;
evaluating each set of weights in the first plurality, wherein evaluating includes, for each set of weights:
assigning the set of weights to a neural network;
presenting training data to an input of the neural network; and
calculating a fitness score for the set of weights based on a fitness function that is dependent on an output of the neural network,
wherein evaluating each set of weights occurs at least partly concurrently, such that two or more sets of weights in the first plurality are evaluated at the same time; and
generating a second plurality of sets of weights for the neural network, wherein generating the second plurality includes applying a training algorithm to the sets of weights of the first plurality to generate the second plurality, the sets of weights of the second plurality being dependent on the sets of weights of the first plurality and their respective fitness scores.

2. The method of claim 1, wherein the evaluating is performed concurrently by a cluster of central processing units (CPUs) or by a graphics processing unit (GPU).

3. The method of any preceding claim wherein the first plurality is an initial plurality, and wherein the generating of the initial plurality includes randomly generating each set of weights in the initial plurality using a random number generator.

4. The method of any preceding claim, wherein the training algorithm is an artificial evolution algorithm including one or more operations of elitism, mutation, recombination and truncation for generating the second plurality of sets of weights; and the operations are applied to one or more of the sets of weights of the first plurality based on the fitness scores of the sets of weights of the first plurality.

5. The method of claim 4 wherein generating the first plurality and generating the second plurality includes encoding each set of weights as an artificial chromosome.

6. The method of any preceding claim, wherein evaluating each of the sets of weights of the first plurality occurs concurrently, such that every set of weights in the first plurality is evaluated at the same time.

7. The method of any preceding claim wherein the training data and the fitness function are dependent on a specific task that the neural network is being trained for, wherein the specific task is image classification, image segmentation, or object recognition.

8. The method of any preceding claim, wherein, when evaluating, the fitness score for a set of weights is greater when the output of the neural network, fitted with the set of weights, correctly indicates a property of the training data.

9. The method of claim 9, wherein, when generating the second plurality, the method further comprises:
ranking the set of weights of the first plurality according to their respective fitness scores; and
generating the second plurality from the existing plurality by applying the training algorithm to the first plurality; wherein the training algorithm manipulates the sets of weights of the first plurality based on their ranking to generate the second plurality.

10. The method of any preceding claim, further including repeating the evaluating step with respect to the second plurality of sets of weights.

11. The method of claim 10, further comprising repeating the generating step and the evaluating step iteratively up to an nth plurality, such that the nth plurality is generated by applying the training algorithm to the sets of weights of the n−1th plurality to generate the nth plurality, the sets of weights of the nth plurality being dependent on the sets of weights of the n−1th plurality and their respective fitness scores; wherein n is a positive integer and n≥3.

12. The method of claim 10 or 11 further comprising:
receiving a user selection of a set of weights in any plurality; and
applying a biasing factor to the fitness score for the selected set of weights, such that the selected set of weights has a greater fitness score.

13. The method of any of claims 10 to 12, further comprising:
selecting a final set of weights from any plurality;
saving the final weights to a memory; and
subsequently inputting the final weights into a neural network for identifying a feature of an environment of a vehicle.

14. The method any of any of claims 10 to 12, further comprising:
selecting one or more sets of weights from any plurality;
repeating the evaluating step for each of the one or more sets of weights using different training data presented to the input of the neural network.

15. The method of claim 14, further comprising:
selecting a final set of weights from the one or more sets of weights for which the evaluating step has been repeated;
saving the final weights to a memory; and
subsequently inputting the final weights into a neural network for identifying a feature of an environment of a vehicle.

16. The method of claim 14 or 15, wherein the selecting one or more sets of weights from any plurality includes selecting all sets of weights across all generations that have a fitness score above a cut-off threshold.

17. The method any preceding claim wherein the method is for training a neural network for controlling the movement of a vehicle.

18. The method of any preceding claim, wherein the training data presented to the input of the neural network is live data that is being captured in real time.

19. The method of claim 18, wherein the live data is simultaneously processed by a trained neural network to identify a feature of an environment of a vehicle.

20. The method of claim 18 or 19, further comprising dynamically updating the weights of a trained neural network with a set of weights generated using the live data as the training data.

21. A system for training a neural network, the system comprising a primary module and a secondary module that are communicatively coupled;
the primary module configured to generate a first plurality including a plurality of sets of weights for a neural network;
the secondary module configured to evaluate each set of weights in the first plurality, wherein evaluating includes, for each set of weights:
assigning the set of weights to a neural network;
presenting training data to an input of the neural network; and
calculating a fitness score for the set of weights based on a fitness function that is dependent on an output of the neural network,
wherein the secondary module is configured to evaluate each set of weights at least partly concurrently, such that two or more sets of weights in the first plurality are evaluated at the same time; and
the primary module being further configured to generate a second plurality of sets of weights for the neural network, by applying a training algorithm to the sets of weights of the first plurality to generate the second plurality, the sets of weights of the second plurality being dependent on the sets of weights of the first plurality and their respective fitness scores.

22. The system of claim 21 wherein the primary module includes a central processing unit (CPU).

23. The system of claim 21 or 22 wherein the secondary module includes a graphics processing unit (GPU) which comprises a plurality of parallel computing blocks, wherein each of the plurality of parallel computing blocks is configured to evaluate a set of weights from the first plurality, such that the plurality of parallel computing blocks are configured to concurrently evaluate multiple sets of weights from the first plurality.

24. The system of claim 23, wherein the primary module is configured to send the first plurality to the GPU, and the GPU is configured to divide the plurality of sets of weights in the first plurality between the parallel computing blocks for evaluation.

25. The system of claim 21 or 22 wherein the secondary module includes a cluster of multiple central processing units (CPUs), wherein each of the CPUs in the cluster is configured to evaluate a set of weights from the first plurality, such that the cluster of CPUs are configured to concurrently evaluate multiple sets of weights from the first plurality.

26. The system of claim 25 wherein the primary module is configured to:
send a set of weights of the first plurality to each CPU in the cluster of CPUs for evaluation, and
subsequently receive a fitness score from each respective CPU in the cluster of CPUs, the fitness score corresponding to the set of weights evaluated by each respective CPU.

27. The system of any of claims 21 to 26, wherein the primary module is further configured to send the second plurality to the secondary module for evaluation of the sets of weights of the second plurality; and the secondary module is further configured to evaluate the second plurality.

28. The system of claim 27 wherein the secondary module and the primary module are configured to repeat the process of evaluating a plurality an subsequently generating a next plurality iteratively up to an nth plurality, such that the nth plurality is configured to be generated by the primary module by applying the training algorithm to the sets of weights of the n−1th plurality to generate the nth plurality, the sets of weights of the nth plurality being dependent on the sets of weights of the n−1th plurality and their respective fitness scores configured to be determined by the secondary module; wherein n is a positive integer and n≥3.

29. The system of any of claims 21 to 28, further comprising a memory, wherein the primary module is configured to store at least one set of weights at the memory for transfer to a neural network for identifying a feature of an environment of a vehicle.

30. The system of any of claims 21 to 29, further comprising a user-interface for receiving an input from the user; the user-interface configured to:
receive a user selection of a set of weights in any plurality; and
apply a biasing factor to the fitness score for the selected set of weights, such that the selected set of weights has a greater fitness score.

31. The system of any of claims 21 to 30, wherein the training algorithm is an artificial evolution algorithm, and wherein the primary module is configured to encode each set of weights in a plurality as an artificial chromosome.
